(19) United States
(12) Patent Application Publication
(10) Pub. No.: US 2024/0178933 A1
(43) Pub. Date: May 30, 2024

(54) TECHNIQUES TO FACILITATE RATE MATCHING AND CSI CONFIGURATIONS FOR RATE-SPLITTING MU-MIMO COMMUNICATIONS

(71) Applicant: QUALCOMM Incorporated, San Diego, CA (US)

(72) Inventors: Ahmed Abdelaziz Ibrahim Abdelaziz ZEWAIL, San Diego, CA (US); Mostafa KHOSHNEVISAN, San Diego, CA (US); Xiaoxia ZHANG, San Diego, CA (US); Jing SUN, San Diego, CA (US)

(21) Appl. No.: 18/059,976

(22) Filed: Nov. 29, 2022

(51) Int. Cl. H04L 1/00; H04B 7/0452; H04B 7/0456; H04B 7/06

(52) U.S. Cl. CPC H04L 1/0013; H04B 7/0452; H04B 7/0456; H04B 7/0626

(57) ABSTRACT

Apparatus, methods, and computer-readable media for facilitating wireless communication employing MU-MIMO are disclosed herein. An example method for wireless communication at a user equipment (UE) includes receiving common rate matching information for a common codeword for a rate-splitting MU-MIMO communication. The example method also includes decoding the common codeword of the rate-splitting MU-MIMO communication using the common rate matching information.

### TECHNICAL FIELD

The present disclosure relates generally to communication systems, and more particularly, to wireless communication employing multiple user-multiple input multiple output (MU-MIMO) communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may receive common rate matching information for a common codeword for a rate-splitting MU-MIMO communication. The example apparatus may also decode the common codeword of the rate-splitting MU-MIMO communication using the common rate matching information.

In another aspect of the disclosure, a method, a computer-readable medium, and an apparatus are provided for wireless communication. An apparatus may include a network entity, such as a base station. The example apparatus may provide common rate matching information for a common codeword for a rate-splitting MU-MIMO communication. The example apparatus may also provide the rate-splitting MU-MIMO communication comprising the common codeword based on the common rate matching information.

In another aspect of the disclosure, a method, a computer-readable medium, and an apparatus are provided for wireless communication. An apparatus may include a network entity, such as a base station. The example apparatus may configure a first rate matching pattern for a first UE. The example apparatus may also configure a second rate matching pattern for a second UE to align with the first rate matching pattern for the first UE. Additionally, the example apparatus may provide rate-splitting MU-MIMO communication based on the first rate matching pattern and the second rate matching pattern. The rate-splitting MU-MIMO communication may include a common codeword that is common to the first UE and the second UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example transmitter generating a rate-splitting MU-MIMO communication for a first UE and a second UE, in accordance with various aspects of the present disclosure.

FIG. 5 is a diagram illustrating an example implementation of decoding a rate-splitting MU-MIMO communication at a first UE, in accordance with various aspects of the present disclosure.

FIG. 6 depicts a table illustrating example fields that may be included in a DCI format message, in accordance with various aspects of the present disclosure.

FIG. 7 depicts an example of a rate matching pattern parameter, in accordance with various aspects of the present disclosure.

FIG. 8 illustrates an example communication flow between a network entity and a UE, in accordance with various aspects of the present disclosure.

FIG. 9A illustrates a portion of an example DCI including a rate matching indicator field, in accordance with various aspects of the present disclosure.

FIG. 9B illustrates a portion of an example DCI including a rate matching indicator field, in accordance with various aspects of the present disclosure.

FIG. 9C illustrates a portion of an example DCI including a rate matching indicator field and a common rate matching indicator field, in accordance with various aspects of the present disclosure.

FIG. 10A illustrates a portion of an example DCI including a ZP CSI-RS trigger field, in accordance with various aspects of the present disclosure.

FIG. 10B illustrates a portion of an example DCI including a ZP CSI-RS trigger field, in accordance with various aspects of the present disclosure.

FIG. 10C illustrates a portion of an example DCI including a ZP CSI-RS trigger field and a common ZP CSI-RS trigger field, in accordance with various aspects of the present disclosure.

FIG. 11 illustrates an example communication flow between a network entity, a first UE, and a second UE, in accordance with various aspects of the present disclosure.

FIG. 12 is a flowchart of a method of wireless communication at a UE, in accordance with the teachings disclosed herein.

FIG. 13 is a flowchart of a method of wireless communication at a UE, in accordance with the teachings disclosed herein.

FIG. 14 is a diagram illustrating an example of a hardware implementation for an example apparatus and/or network entity.

FIG. 15 is a flowchart of a method of wireless communication at a network entity, in accordance with the teachings disclosed herein.

FIG. 16 is a flowchart of a method of wireless communication at a network entity, in accordance with the teachings disclosed herein.

FIG. 17 is a flowchart of a method of wireless communication at a network entity, in accordance with the teachings disclosed herein.

FIG. 18 is a diagram illustrating an example of a hardware implementation for an example network entity.

### DETAILED DESCRIPTION

A MIMO system includes multiple transmit antennas and multiple receive antennas for data transmission. Data streams may be transmitted on spatial channels associated with MIMO channels. A multiple user-multiple input multiple output (MU-MIMO) system allows resource blocks to be shared by a group of UEs. In some aspects, the group of UEs may be selected so that transmissions to the respective UEs are separated in a spatial domain. A MU-MIMO system may increase spectral efficiency as the resource blocks may be allocated to multiple UEs.

In some aspects, rate-splitting techniques may be utilized with MU-MIMO communications as rate-splitting may achieve larger degrees of freedom and/or increased capacity. When employing rate-splitting, messages of individual users (e.g., co-scheduled UEs) are split into common parts and private parts. The common part of individual messages of two or more co-scheduled UEs may be concatenated into a common message. The common message may then be encoded and modulated to generate a common stream. The common stream may have one or more layers. The private part of individual messages are separately encoded and modulated to generate private streams for the respective UEs.

At the receiver side, a UE receiving a rate-splitting MU-MIMO communication may decode the common message first. The UE may then apply successive interference cancelation (SIC) processing techniques to decode a private message of the rate-splitting MU-MIMO communication that is intended for the UE.

Thus, to apply rate-splitting MU-MIMO communications, the network may schedule each co-scheduled UE with two codewords, e.g., a private codeword and a common codeword. The common codeword is common between the co-scheduled UEs. The private codeword is UE-specific.

Rate matching generally refers to the process of repeating or puncturing bits on a transport channel. Rate matching may be performed to avoid a collision, for example, when resources allocated to one type of transmission overlap with resources of another type of transmission. For example, for a rate-splitting MU-MIMO communication, rate matching may facilitate avoiding a collision between receiving the common message and the respective private message at a UE.

A channel state information—reference signal (CSI-RS) is a downlink transmission that may be associated with different purposes. In some aspects, a network may configure a UE to use a CSI-RS for one or more purposes, such as CSI reporting, beam management, mobility, radio link failure detection, beam failure detection and recover, time and/or frequency resource synchronization, etc. A CSI-RS may be configured as a zero-power (ZP) CSI-RS or a non-zero-power (non-ZP or NZP) CSI-RS. A non-ZP CSI-RS may be generated by a sequence and mapped to resource elements. For a ZP CSI-RS, the UE may assume that the resource elements are not used for PDSCH.

When a UE receives a non-ZP CSI-RS, the UE may process the CSI-RS and provide a report based on the processing of the non-ZP CSI-RS. Additionally, the UE may assume that resources associated with the non-ZP CSI-RS are for PDSCH communications and, thus, may not rate match around the respective resources. In contrast, when a UE receives a ZP CSI-RS, the UE may use the corresponding resources for rate matching and forego providing a report based on the ZP CSI-RS and, thus, may assume that the resources are not for PDSCH communications. That is, a ZP CSI-RS may be configured to define reserved resources with a resolution of individual resource elements (or tones). A ZP CSI-RS defines a set of resources (e.g., REs or tones) that do not contain transmission for the UE.

When co-scheduled UEs are configured to receive a rate-splitting MU-MIMO communication, the UEs are assumed to decode the common message first, and then to perform SIC processing techniques to decode their respective private messages or to jointly decode the common message and respective private message.

Although it may be beneficial for the rate matching pattern to be unified for the common message so that all co-scheduled UEs can decode the common message correctly, in some aspects, the rate matching pattern may not be guaranteed to be unified. For the private streams, the rate matching patterns may be different from one UE to another (e.g., may be UE-specific), but may not impact the decoding of the private streams.

Additionally, in some aspects, a non-ZP CSI-RS may be multiplexed with a common message. Although it may be beneficial for the non-ZP CSI-RS to be unified for the common message or to have a configuration that is at least known to all of the co-scheduled UEs so that the co-scheduled UEs can decode the common message properly, in some aspects, the non-ZP CSI-RS may not be guaranteed to be unified for the common message and/or may not have a configuration that is known to all of the co-scheduled UEs.

Moreover, while a UE may use ZP CSI-RS resources (e.g., tones) to measure interference, the resources may be different between the common streams and the private streams. For example, a network may configure first ZP CSI-RS resources for a common stream and second ZP CSI-RS resources for a private stream. In some such examples, the first ZP CSI-RS resources and the second ZP CSI-RS resources may be different, which may result in the ZP CSI-RS resources being non-unified between the common streams and the private streams.

Aspects disclosed herein provide techniques for unifying rate matching patterns and CSI configurations for decoding common messages across co-scheduled UEs. In some aspects, separate rate matching patterns and CSI configurations may be configured for the common message (sometimes referred to herein as a “common codeword”) and the private message (sometimes referred to herein as a “private codeword”). In some aspects, co-scheduled UEs may be configured with rate-splitting rate match information that may include a same rate matching pattern and CSI configuration for the common message and the private message. For example, the rate matching pattern and the CSI configuration used to decode the common message may also be used to decode the private message of a rate-splitting MU-MIMO communication. In some aspects, the network may configure different configurations of non-ZP CSI and ZP CSI for co-scheduled UEs. In some such examples, the rate matching may be aligned between different UEs, for example, by designing the NZP CSI-RS pattern and the ZP CSI-RS pattern at the different co-scheduled UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

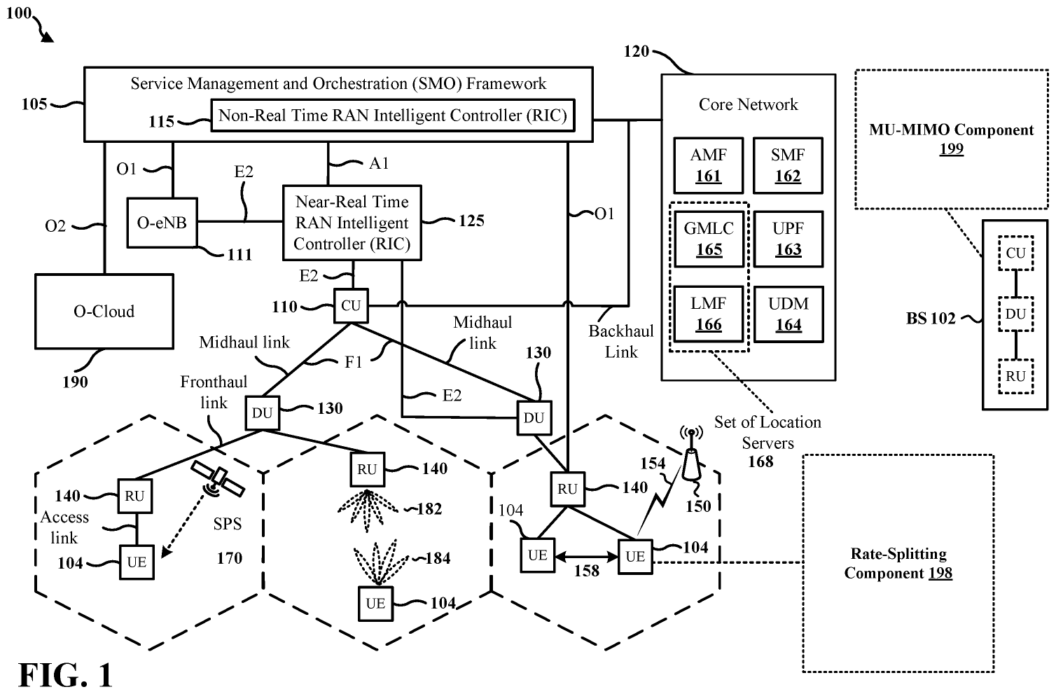

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Y× MHz (× component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a rate-splitting component 198 configured to facilitate aligning rate matching for common streams across co-scheduled UEs of a rate-splitting MU-MIMO communication.

In certain aspects, the rate-splitting component 198 may be configured to receive common rate matching information for a common codeword for a rate-splitting MU-MIMO communication. The example rate-splitting component 198 may also be configured to decode the common codeword of the rate-splitting MU-MIMO communication using the common rate matching information.

In another configuration, a network entity, such as a base station 102 or a component of a base station (e.g., a CU 110, a DU 130, and/or an RU 140), may be configured to manage or more aspects of wireless communication. For example, the base station 102 may include a MU-MIMO component 199 configured to facilitate aligning rate matching for common streams across co-scheduled UEs of a rate-splitting MU-MIMO communication.

In certain aspects, the MU-MIMO component 199 may be configured to provide common rate matching information for a common codeword for a rate-splitting MU-MIMO communication. The example MU-MIMO component 199 may also be configured to provide the rate-splitting MU-MIMO communication comprising the common codeword based on the common rate matching information.

In another aspect, the MU-MIMO component 199 may be configured to configure a first rate matching pattern for a first UE. The example MU-MIMO component 199 may also be configured to configure a second rate matching pattern for a second UE to align with the first rate matching pattern for the first UE. Additionally, the example MU-MIMO component 199 may be configured to provide rate-splitting MU-MIMO communication based on the first rate matching pattern and the second rate matching pattern. The rate-splitting MU-MIMO communication may include a common codeword that is common to the first UE and the second UE.

The aspects presented herein may enable rate matching patterns to be aligned across co-scheduled UEs for the common stream of a rate-splitting MU-MIMO communication, which may facilitate improving communication performance, for example, by increasing spectral efficiency and reliability.

Although the following description provides examples directed to 5G NR, the concepts described herein may be applicable to other similar areas, such as 6G, 5G-advanced, LTE, LTE-A, CDMA, GSM, and/or other wireless technologies.

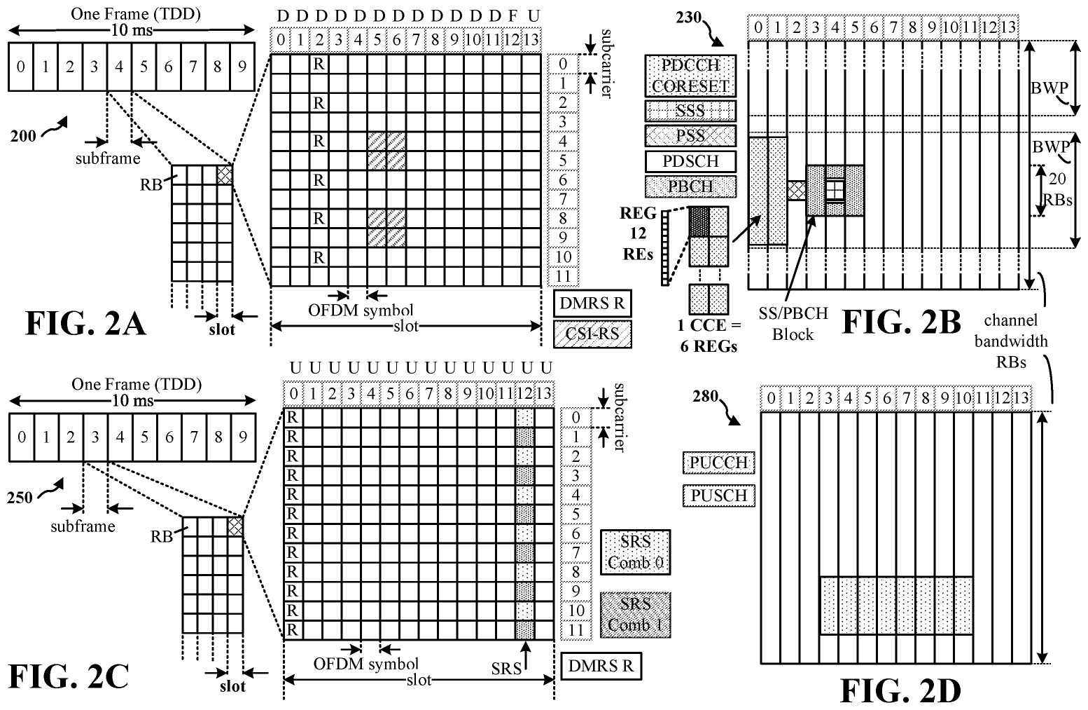

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

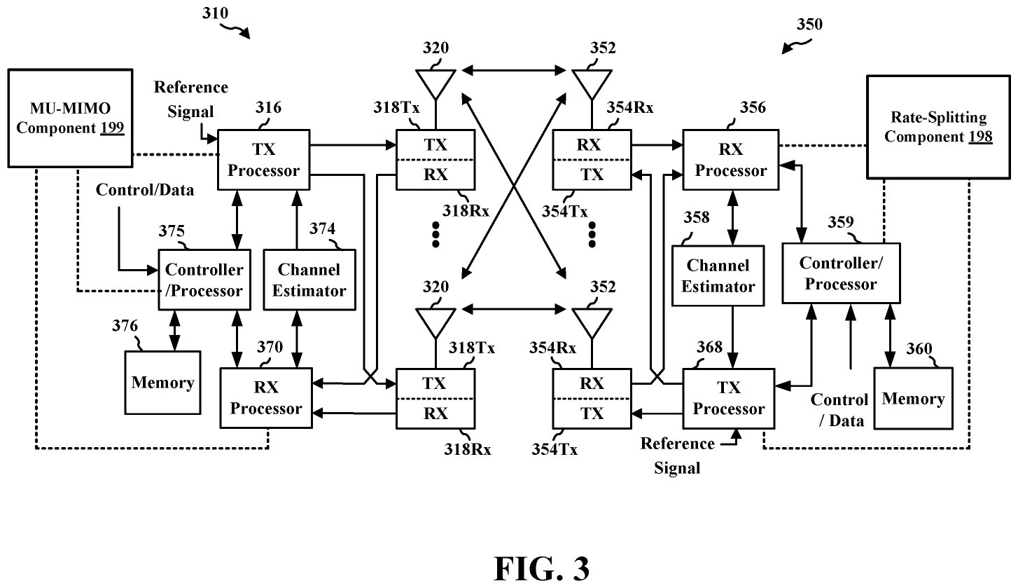

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the rate-splitting component 198 of FIG. 1.

At least one of the TX processor 316, the RX processor 370, and the controller/processor 375 may be configured to perform aspects in connection with the MU-MIMO component 199 of FIG. 1.

A MIMO system includes multiple transmit antennas and multiple receive antennas for data transmission. Data streams may be transmitted on spatial channels associated with MIMO channels. A multiple user-multiple input multiple output (MU-MIMO) system allows resource blocks to be shared by a group of UEs. In some aspects, the group of UEs may be selected so that transmissions to the respective UEs are separated in a spatial domain. A MU-MIMO system may increase spectral efficiency as the resource blocks may be allocated to multiple UEs.

In some aspects, rate-splitting techniques may be utilized with MU-MIMO communications as rate-splitting may achieve larger degrees of freedom and/or increased capacity. When employing rate-splitting, messages of individual users (e.g., co-scheduled UEs) are split into common parts and private parts. The common part of individual messages of two or more co-scheduled UEs may be concatenated into a common message (W_{c}). The common message W_{c} may then be encoded and modulated to generate a common stream (X_{c}). The common stream X_{c} may have one or more layers. The private part of individual messages are separately encoded and modulated to generate private streams (Xₚ) for the respective UEs.

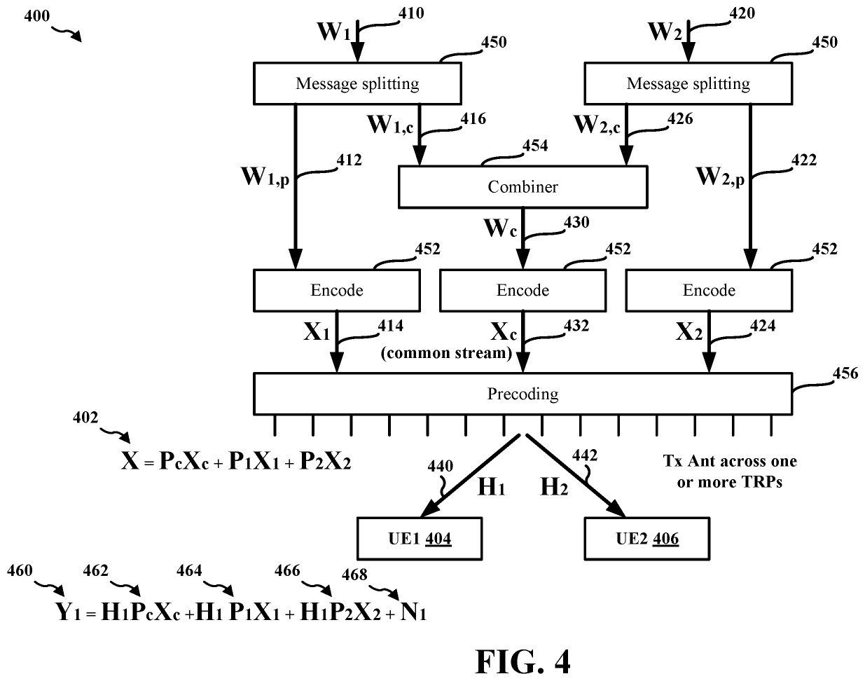

FIG. 4 illustrates an example transmitter 400 generating a rate-splitting MU-MIMO communication 402 for a first UE 404 (“UE1”), and a second UE 406 (“UE2”), as presented herein. In the illustrated example, a first message 410 (W₁) is intended for the first UE 404 and a second message 420 (W₂) is intended for the second UE 406. The respective messages are split by a message splitting component 450 into a common part and a private part. For example, the first message 410 may be split into a first message private part 412 (W_{1,P}) and a first message common part 416 (W_{1,C}). Similarly, the second message 420 may be split into a second message private part 422 (W_{2,P}) and a second message common part 426 (W_{2,C}). The private parts of the individual messages may be separately encoded (e.g., via an encoding component 452) and modulated to generate respective private streams. For example, the first message private part 412 may be encoded and modulated to form a first private stream 414 (X₁). Similarly, the second message private part 422 may be encoded and modulated to form a second private stream 424 (X₂). In the example of FIG. 4, the encoding component 452 may include modulation and mapping to one or more layers in addition to encoding.

As shown in FIG. 4, a combiner component 454 may concatenate the common part of the individual messages of the first UE 404 and the second UE 406 to form a common message 430 (W_{c}). For example, the combiner component 454 may combine the first message common part 416 and the second message common part 426 to form the common message 430. An encoding component 452 may encode and modulate the common message 430 to form a common stream 432 (X_{c}).

In the illustrated example of FIG. 4, a precoding component 456 may apply precoding to each of the respective streams to form the rate-splitting MU-MIMO communication 402. For example, the common stream 432 may be precoded with a common precoder (P_{c}), the first private stream 414 may be precoded with a first precoder (P₁), and the second private stream 424 may be precoded with a second precoder (P₂). The rate-splitting MU-MIMO communication 402 including the precoded common stream (P_{c}X_{c}), the precoded first private stream (P₁X₁), and the precoded second private stream (P₂X₂) may be transmitted by the multiple transmit antennas of the transmitter 400. The rate-splitting MU-MIMO communication 402 is transmitted across a channel, which may be represented by a channel coefficient matrix (H). As shown in FIG. 4, each UE experiences a respective channel response. For example, the first UE 404 may experience a first channel response 440 (H₁) and the second UE 406 may experience a second channel response 442 (H₂).

In the illustrated example of FIG. 4, the first UE 404 receives a rate-splitting MU-MIMO communication 460 (Y₁) that is modified by the first channel response 440. The rate-splitting MU-MIMO communication 460 includes a common component 462 (H₁P_{c}X_{c}), a first private component 464 (H₁P₁X₁), a second private component 466 (H₁P₂X₂), and a noise component 468 (N₁).

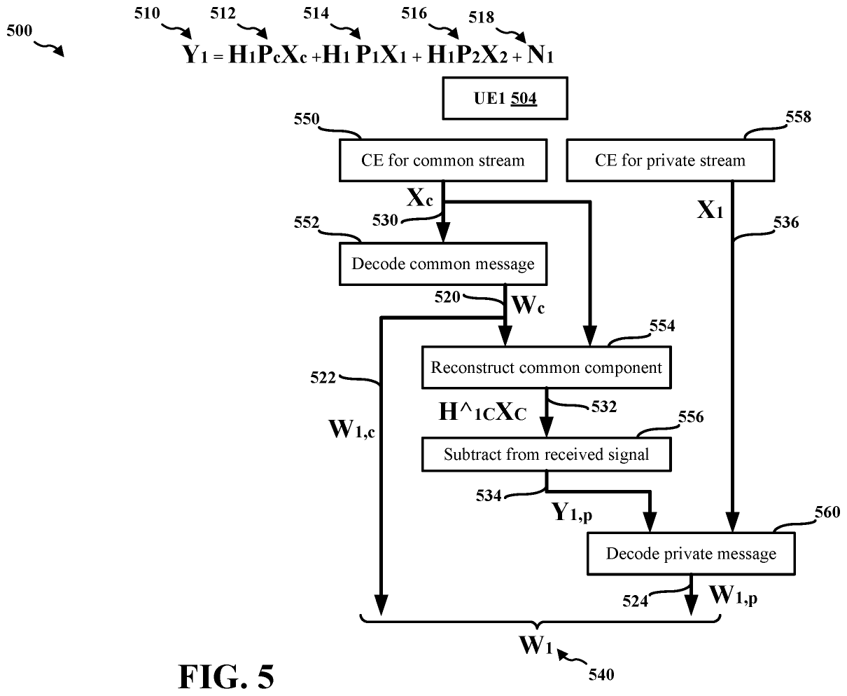

FIG. 5 is a diagram 500 illustrating an example implementation of decoding a rate-splitting MU-MIMO communication 510 at a first UE 504 (“UE1”), as presented herein. The first UE 504 may correspond to the first UE 404 of FIG. 4. The rate-splitting MU-MIMO communication 510 may correspond to the rate-splitting MU-MIMO communication 460 of FIG. 4. For example, the rate-splitting MU-MIMO communication 510 includes a common component 512 (H₁P_{c}X_{c}), a first private component 514 (H₁P₁X₁), a second private component 516 (H₁P₂X₂), and a noise component 518 (N₁).

In the illustrated example of FIG. 5, the first UE 504 decodes a common message 520 (W_{c}) of the rate-splitting MU-MIMO communication 510 first. In some aspects, a part of the individual message for each UE (e.g., a first message common part 522 (W_{1,C})) may be embedded in the common message 520, which may be the data intended for the first UE 504. Thus, decoding the common message 520 first may enable the first UE 504 to obtain the first message common part 522.

In some aspects, the first UE 504 may apply successive interference cancelation (SIC) processing techniques to decode a first private message 524 (W_{1,P}) of the rate-splitting MU-MIMO communication 510. The SIC processing technique may be beneficial when different data in a communication (e.g., a rate-splitting MU-MIMO communication) are inter-dependent. For example, with SIC processing techniques, whenever a data packet is recovered, the interference that the data packet causes to not-yet-recovered data packets is estimated and canceled prior to performing the detection to obtain the detected symbol blocks for these other data packets. For example, after the first UE 504 decodes the common message 520, the first UE 504 may remove (e.g., cancel) the respective signal from the rate-splitting MU-MIMO communication 510 prior to the processing to receive a next transmitted signal. Thus, the SIC processing technique performs a number of iterations and where one iteration is performed for each transmitted signal (or message) to be recovered.

As shown in FIG. 5, a channel estimation component 550 estimates an effective channel response corresponding to a common stream 530 (X_{c}). For example, the channel estimation component 550 may estimate a first precoded channel response (H^{∧}_{1c}) based on an estimate of the channel (H^{∧}₁) and the common precoder (P_{c}) associated with the common component 512 of the rate-splitting MU-MIMO communication 510 to decode the common stream 530. A decoding component 552 may then process the common stream 530 to decode the common message 520. In the example of FIG. 5, the decoding component 552 may include demodulation and demapping, in addition to decoding. The first UE 504 may then separate the first message common part 522 from the common message 520.

To decode the first private message 524, a reconstruction component 554 may reconstruct the common stream to generate a reconstructed common component 532 (H^{∧}_{1c}X_{c}). For example, the reconstruction component 554 may re-encode the common message 520. The UE 504 may then multiply the re-encoded common message by the estimated effective channel (e.g., the estimated first precoded channel response (H^{∧}_{1c})) to generate the reconstructed common component 532. A subtraction component 556 may subtract the reconstructed common component 532 from the rate-splitting MU-MIMO communication 510 to obtain a private message signal 534 (Y_{1,P}). Assuming perfect channel estimation and successful decoding, the private message signal 534 may be determined by re-writing the rate-splitting MU-MIMO communication 510, as shown in Equation 1 (below).

$${Y}_{1 , P} = {Y}_{1} - {{H}^{⋀}}_{1 c} {X}_{C} = {H}_{1} {P}_{1} {X}_{1} + {H}_{1} {P}_{2} {X}_{2} + {N}_{1} + ( {H}_{1} {P}_{C} - {{H}^{⋀}}_{1 c} ) {X}_{C} \qquad Equation 1$$

As shown in Equation 1, the private message signal 534 may be equal to the rate-splitting MU-MIMO communication 510 (Y₁) minus the reconstructed common component 532. The private message signal 534 is also equal to the first private component 514 plus the second private component 516 plus the noise component 518 plus a modified common component (H₁P_{c}−H^{∧}_{1c})X_{c}. The modified common component may be represented by the product of the common stream 530 and a modifier component. The modifier component may be represented by a difference in the product of the first channel response (H₁) and the common precoder (P_{c}) and the estimated first precoded channel response (H^{∧}_{1c}). In the example of Equation 1, the modifier component may be treated as noise.

As shown in FIG. 5, a channel estimation component 558 estimates an effective channel response corresponding to a private stream 536. For example, the channel estimation component 558 may estimate the first precoded channel response (H^{∧}_{1c}). The UE 504 may then use the estimated first precoded channel response (H^{∧}_{1c}) and the first precoder (P₁) associated with the first private component 514 of the rate-splitting MU-MIMO communication 510 to decode the private stream 536. A decoding component 560 may then process the private stream 536 to decode the first private message 524. As shown in FIG. 5, the first message common part 522 and the first private message 524 may be combined (e.g., concatenated) to form a first message 540 (W₁) that is intended for the first UE 504. It may be appreciated that the first message 540 may correspond to the first message 410 of FIG. 4.

Rate matching generally refers to the process of repeating or puncturing bits on a transport channel. Rate matching may be performed to avoid a collision, for example, when resources allocated to one type of transmission overlap with resources of another type of transmission. For example, for a rate-splitting MU-MIMO communication, rate matching may facilitate avoiding a collision between receiving the common message and the respective private message at a UE. One or more rate matching patterns may be configured at a UE via higher layer signaling, such as RRC signaling. A rate matching pattern to apply for a communication (e.g., a rate-splitting MU-MIMO communication) may be indicated to the UE via downlink control information.

A network may provide downlink control information (DCI) to a UE to facilitate resource allocations for uplink communications, downlink communications, UE group common signaling, etc. Each DCI includes one or more respective fields that provide information to a receiving UE. In some aspects, the information that the DCI provides may be based on its DCI format. For example, a DCI format 0_1 is a DCI format that provides uplink resource allocations on the PUSCH, a DCI format 1_1 is a DCI format that provides downlink resource allocations on the PDSCH, etc. A receiving UE may be expected to deduce which DCI format is being received, for example, based on one or more of a PDCCH search space set, a type of Radio Network Temporary Identifier (RNTI) used to scramble cyclic redundancy check (CRC) bits that are attached to the DCI payload, a size of the DCI payload, and/or information within the DCI payload.

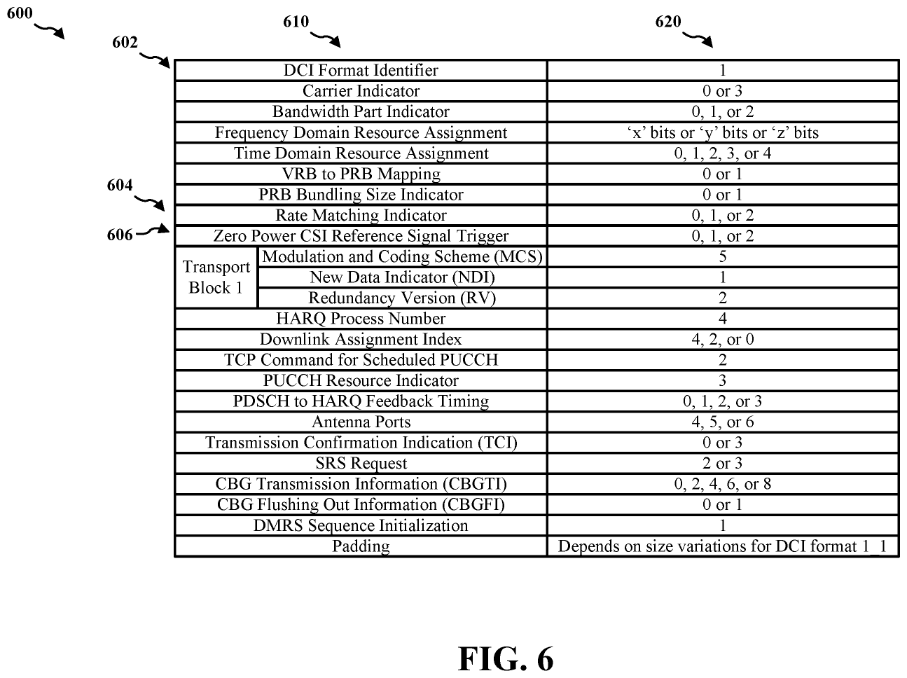

As mentioned above, a DCI may include one or more fields that provide information to a UE based on its respective DCI format. FIG. 6 depicts a table 600 illustrating example fields that may be included in a DCI format 1_1 message, as presented herein. As shown in FIG. 6, a first column 610 indicates different fields and a second column 620 indicates a number of bits within the DCI message associated with the respective field. For example, a DCI Format Identifier field 602 is a 1-bit field that may be used to differentiate between DCI format 0_1 and DCI format 1_1. It may be appreciated that the example fields includes in the table 600 are illustrative and that other example DCI format 1_1 messages may include additional or alternate fields.

As shown in FIG. 6, the example table 600 includes a rate matching indicator field 604 that may be 0 bits, 1 bit, or 2 bits long. In some examples, the size of the rate matching indicator field 604 may be configured by a rate matching pattern parameter or a rate matching pattern information element (IE). The rate matching pattern parameter, which may be referred to as a “rateMatchPattern” parameter or by any other suitable name, may be a higher layer parameter. For example, the rate matching pattern parameter may be configured via RRC signaling between a UE and a network.

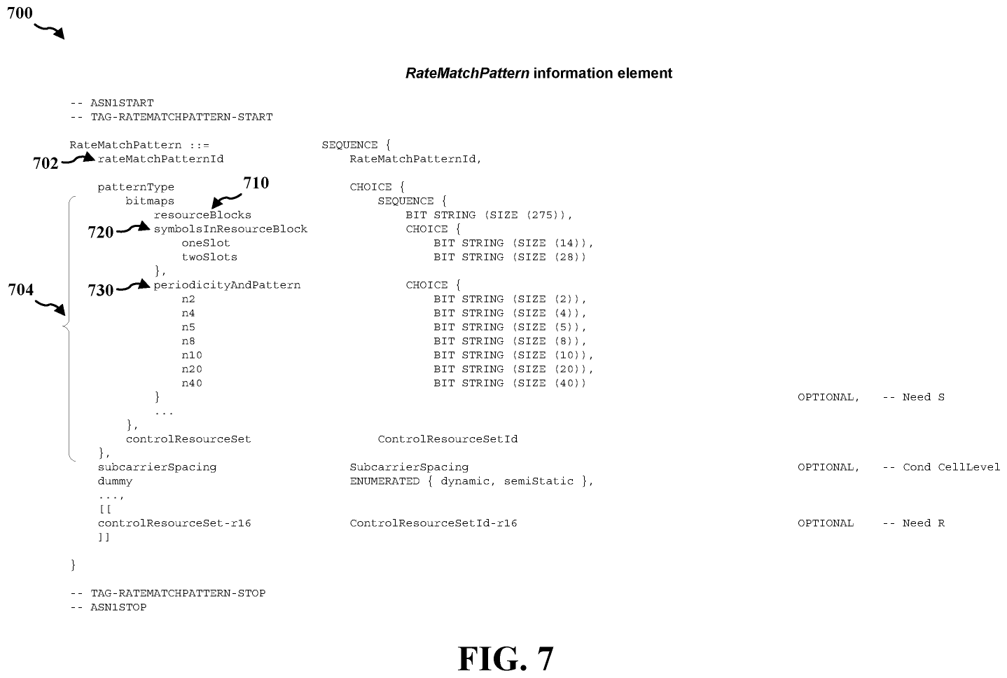

FIG. 7 depicts an example of a rate matching pattern parameter 700, as presented herein. The rate matching pattern parameter 700 may be used to configure a rate matching pattern for PDSCH. For example, the rate matching pattern parameter 700 may configure a rate matching pattern for a rate matching pattern identifier 702 (which may be referred to as a “rateMatchPatternID” or by any other suitable name).

As shown in FIG. 7, the rate matching pattern parameter 700 includes a first field 704 (“bitmaps”) that indicates a rate matching pattern via a pair of bitmaps (e.g., a first bitmap 710 and a second bitmap 720) to define the rate matching pattern within one slot or two slots. Additionally, a third bitmap 730 may define the repetition pattern with which the pattern defined by the first bitmap 710 and the second bitmap 720 occurs.

In the illustrated example of FIG. 7, the first bitmap 710 (“resourceBlocks”) contains an RB-level bitmap in the frequency domain. A bit in the first bitmap 710 set to a first value (e.g., a “1”) indicates that the UE is to apply rate matching in the corresponding resource block and in accordance with the second bitmap 720. In some examples, the first bitmap 710 may identify common resource blocks (CRBs) when used as a cell-level rate matching pattern. In some examples, the first bitmap 710 may identify physical resource blocks inside a BWP when used as a BWP-level rate matching pattern.

In the illustrated example of FIG. 7, the second bitmap 720 (“symbolsInResourceBlock”) contains a symbol-level bitmap in the time domain. A bit in the second bitmap 720 set to a first value (e.g., a “1”) indicates that the UE is to rate matching around the corresponding symbol. The second bitmap 720 may correspond to one slot or two slots.

The third bitmap 730 (“periodicityAndPattern”) indicates a time domain repetition pattern at which the pattern defined by the first bitmap 710 and the second bitmap 720 recurs. In some aspects, this slot pattern may repeat itself continuously.

Thus, it may be appreciated that the first bitmap 710, the second bitmap 720, and the third bitmap 730 may configure a particular rate matching pattern (e.g., may configure the rate matching pattern for the rate matching pattern identifier 702). Additionally, based on the number of rate matching patterns configured, the bits of the rate matching indicator field 604 of FIG. 6 may include 0 bits, 1 bit, or 2 bits. For example, the size of the rate matching indicator field 604 may be 0 bits when zero rate matching patterns are configured, may be 1 bit when up to two zero rate matching patterns are configured, and may be 2 bits when up to four zero rate matching patterns are configured.

Additionally, when a UE receives a DCI including a rate matching indicator field, such as the rate matching indicator field 604 of the DCI format 1_1 of FIG. 6, the UE may use the value of the rate matching indicator to determine a rate matching pattern identifier and apply the respective rate matching pattern. Thus, when the UE is configured with one or more rate matching patterns (e.g., via the first bitmap 710, the second bitmap 720, and/or the third bitmap 730), the UE can determine a set of resource blocks and symbols of a slot that are not available for PDSCH reception. For example, the UE may assume that the resource elements (REs) in the rate matching pattern are not available for PDSCH and, thus, the UE will rate matching around them.

It may be appreciated that since the rate matching pattern parameter is configured via higher layer signaling, such as RRC signaling, the rate matching patterns configured at a UE are UE-specific rate matching patterns. That is, a first rate matching pattern (“rateMatchPattern01”) received at a first UE and a second UE may be different rate matching patterns.

A CSI-RS is a downlink transmission that may be associated with different purposes. In some aspects, a network may configure a UE to use a CSI-RS for one or more purposes, such as CSI reporting, beam management, mobility, radio link failure detection, beam failure detection and recover, time and/or frequency resource synchronization, etc. A CSI-RS may be configured as a zero-power (ZP) CSI-RS or a non-zero-power (non-ZP or NZP) CSI-RS. A ZP CSI-RS may be configured by a ZP CSI-RS resource IE, which may be referred to as a “ZP-CSI-RS-Resource” IE or by any other suitable name. A non-ZP CSI-RS may be configured by a higher layer parameter, such as a non-ZP CSI-RS resource IE (may be referred to as a “NZP-CSI-RS-Resource” IE or by any other suitable name). In some aspects, the non-ZP CSI-RS may be configured via a CSI-RS Resource mobility field of a CSI-RS resource configuration mobility IE. The CSI-RS resource mobility field may be referred to as a “CSI-RS-Resource-Mobility” field or by any other suitable name. The CSI-RS resource configuration mobility IE may be referred to as a “CSI-RS-ResourceConfigMobility” IE or by any other suitable name.

A non-ZP CSI-RS may be generated by a sequence and mapped to resource elements. For a ZP CSI-RS, the UE may assume that the resource elements are not used for PDSCH. For example, the UE may perform measurement/reception on channels/signals except PDSCH regardless of whether they collide with ZP CSI-RS or not.

When a UE receives a non-ZP CSI-RS, the UE may process the CSI-RS and provide a report based on the processing of the non-ZP CSI-RS. Additionally, the UE may assume that resources associated with the non-ZP CSI-RS are for PDSCH communications and, thus, may not rate match around the respective resources. In contrast, when a UE receives a ZP CSI-RS, the UE may use the corresponding resources for rate matching and forego providing a report based on the ZP CSI-RS and, thus, may assume that the resources are not for PDSCH communications. That is, a ZP CSI-RS may be configured to define reserved resources with a resolution of individual resource elements (or tones). A ZP CSI-RS defines a set of resources (e.g., REs or tones) that do not contain transmission for the UE.

A ZP CSI-RS may be configured with aperiodic, semi-periodic, or periodic triggering. In some examples, aperiodic triggering may be based upon a ZP CSI-RS trigger field within DCI. For example, and referring again to the example of FIG. 6, the table 600 includes a ZP CSI-RS trigger field 606. In some examples, up to three aperiodic ZP CSI-RS resource sets may be configured per bandwidth part. The ZP CSI-RS trigger field 606 may have a size of 0 bits, 1 bit, or 2 bits. The number of bits associated with the ZP CSI-RS trigger field 606 may depend upon the number of ZP CSI-RS resources sets that have been configured. Additionally, the value of the ZP CSI-RS trigger field 606 may trigger the corresponding ZP CSI-RS resource set. Based on the triggered ZP CSI-RS resource set, the UE may determine which resource elements are not available for reception of PDSCH. That is, the pattern of resources associated with the ZP CSI-RS resource set may be at an RE-level.

When co-scheduled UEs are configured to receive a rate-splitting MU-MIMO communication, the UEs are assumed to decode the common message first, and then to perform SIC processing techniques to decode their respective private messages or to jointly decode the common message and respective private message.

Although it may be beneficial for the rate matching pattern to be unified for the common message so that all co-scheduled UEs can decode the common message correctly, in some aspects, the rate matching pattern may not be guaranteed to be unified. For the private streams, the rate matching patterns may be different from one UE to another (e.g., may be UE-specific), but may not impact the decoding of the private streams.

Additionally, in some aspects, a non-ZP CSI-RS may be multiplexed with a common message. Although it may be beneficial for the non-ZP CSI-RS to be unified for the common message or to have a configuration that is at least known to all of the co-scheduled UEs so that the co-scheduled UEs can decode the common message properly, in some aspects, the non-ZP CSI-RS may not be guaranteed to be unified for the common message and/or may not have a configuration that is known to all of the co-scheduled UEs.

Moreover, while a UE may use ZP CSI-RS resources (e.g., tones) to measure interference, the resources may be different between the common streams and the private streams. For example, a network may configure first ZP CSI-RS resources for a common stream and second ZP CSI-RS resources for a private stream. In some such examples, the first ZP CSI-RS resources and the second ZP CSI-RS resources may be different, which may result in the ZP CSI-RS resources being non-unified between the common streams and the private streams.

Aspects disclosed herein provide techniques for unifying rate matching patterns and CSI configurations for decoding common messages across co-scheduled UEs. In some aspects, separate rate matching patterns and CSI configurations may be configured for the common message (sometimes referred to herein as a “common codeword”) and the private message (sometimes referred to herein as a “private codeword”). In some aspects, co-scheduled UEs may be configured with rate-splitting rate match information that may include a same rate matching pattern and CSI configuration for the common message and the private message. For example, the rate matching pattern and the CSI configuration used to decode the common message may also be used to decode the private message of a rate-splitting MU-MIMO communication. In some aspects, the network may configure different configurations of non-ZP CSI and ZP CSI for co-scheduled UEs. In some such examples, the rate matching may be aligned between different UEs, for example, by designing the NZP CSI-RS pattern and the ZP CSI-RS pattern at the different co-scheduled UEs.

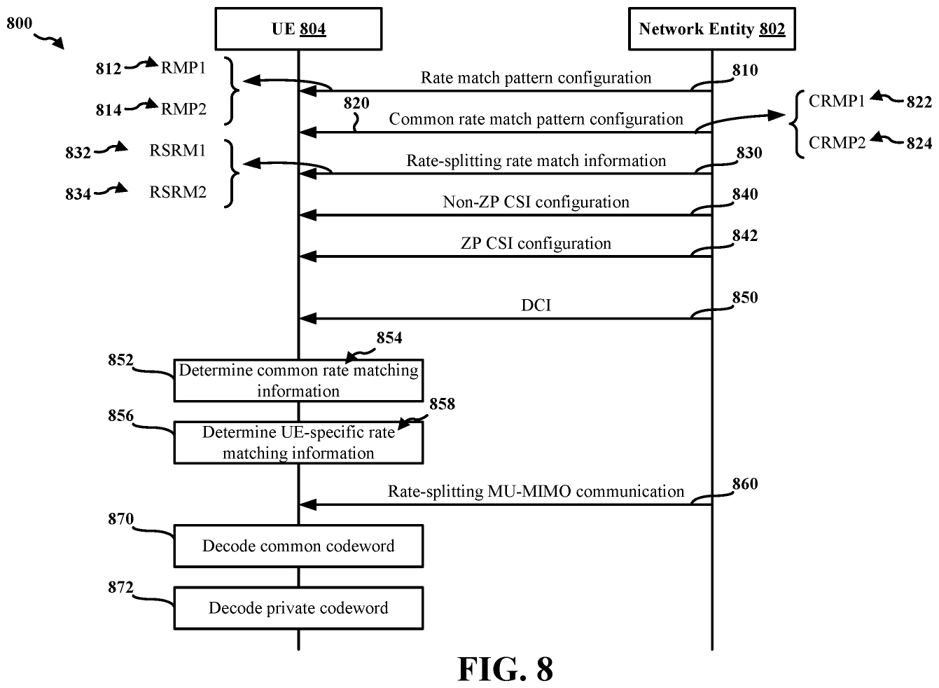

FIG. 8 illustrates an example communication flow 800 between a network entity 802 and a UE 804, as presented herein. One or more aspects described for the network entity 802 may be performed by a component of a base station or a network entity, such as a CU, a DU, and/or an RU. In the illustrated example, the communication flow 800 facilitates aligning rate matching patterns across co-scheduled UEs for the common stream of a rate-splitting MU-MIMO communication which may increase spectral efficiency, capability, data rates, and/or reliability associated with rate-splitting MU-MIMO communications. Aspects of the network entity 802 may be implemented by the base station 102 of FIG. 1 and/or the base station 310 of FIG. 3. Aspects of the UE 804 may be implemented by the UE 104 of FIG. 1 and/or the UE 350 of FIG. 3. Although not shown in the illustrated example of FIG. 8, in additional or alternative examples, the network entity 802 and/or the UE 804 may be in communication with one or more other base stations or UEs.

In the illustrated example of FIG. 8, the network entity 802 may provide (e.g., transmit or output) a rate matching pattern configuration 810 that is received by the UE 804. The network entity 802 may provide the rate matching pattern configuration 810 via RRC signaling. The rate matching pattern configuration 810 may configure one or more rate matching patterns at the UE 804. Thus, the one or more rate matching patterns may be UE-specific rate matching patterns. In the illustrated example of FIG. 8, the rate matching pattern configuration 810 configures a first rate matching pattern 812 (“RMP1”) and a second rate matching pattern 814 (“RMP2”). The respective rate matching patterns may be defined based on respective bitmaps, such as the first bitmap 710 (“resourceBlocks”), the second bitmap 720 (“symbolsInResourceBlock”), and the third bitmap 730 (“periodicityAndPattern”) of the rate matching pattern parameter 700 of FIG. 7.

In the illustrated example of FIG. 8, the network entity 802 provides DCI 850 that is received by the UE 804. The DCI 850 may include a DCI format 1_1 DCI. In the example of FIG. 8, the DCI 850 may provide a resource allocation for a downlink communication, such as a rate-splitting MU-MIMO communication 860.

The UE 804 may perform a determination procedure 852 to determine common rate matching information 854 that the UE 804 may use to decode a common message. The UE 804 may also perform a determination procedure 856 to determine UE-specific rate matching information 858 that the UE 804 may use to decode a private message. The UE 804 may determine the common rate matching information 854 and/or the UE-specific rate matching information 858 via the DCI 850.

As shown in FIG. 8, the network entity 802 may output a rate-splitting MU-MIMO communication 860 that is received by the UE 804. The rate-splitting MU-MIMO communication 860 may include individual messages for two or more UEs. Each of the individual messages may include a common part and a private part. Aspects of the rate-splitting MU-MIMO communication 860 are described in connection with the rate-splitting MU-MIMO communication 460 of FIG. 4 and the rate-splitting MU-MIMO communication 510 of FIG. 5.

The UE 804 may perform a decoding procedure 870 to decode a common codeword of the rate-splitting MU-MIMO communication 860. The UE 804 may use the common rate matching information 854 to decode the common codeword of the rate-splitting MU-MIMO communication 860. Similarly, the UE 804 may perform a decoding procedure 872 to decode a private codeword of the rate-splitting MU-MIMO communication 860. The UE 804 may use the UE-specific rate matching information 858 to decode the private codeword of the rate-splitting MU-MIMO communication 860. Aspects of decoding the common codeword and the private codeword are described in connection with the common message 520 and the first private message 524 of FIG. 5.

In some aspects, to provide unified rate matching patterns and CSI configurations for the common message, techniques disclosed herein utilize separate rate matching patterns and configurations for a common codeword (“c-cw”) and a private codeword (“p-cw”). For example, the network may provide a new rate matching pattern that is shared between the co-scheduled UEs of a rate-splitting MU-MIMO communication. The new rate matching pattern, which may be referred to as a “rateMatchPatternCommon” parameter or by any other suitable name, may be configured and/or updated via RRC signaling and/or a MAC—control element (MAC-CE).

In the illustrated example of FIG. 8, the network entity 802 may provide a common rate matching pattern configuration 820 that is received by the UE 804. The network entity 802 may provide the common rate matching pattern configuration 820 via RRC signaling. The common rate matching pattern configuration 820 may configure one or more common rate matching patterns that are shared between co-scheduled UEs of a rate-splitting MU-MIMO communication. In the illustrated example of FIG. 8, the common rate matching pattern configuration 820 configures a first common rate matching pattern 822 (“CRMP1”) and a second common rate matching pattern 824 (“CRMP2”). The respective common rate matching patterns may be defined based on respective bitmaps, such as a first bitmap (“resourceBlocks”), a second bitmap (“symbolsInResourceBlock”), and a third bitmap (“periodicityAndPattern”) of a common rate matching pattern parameter.

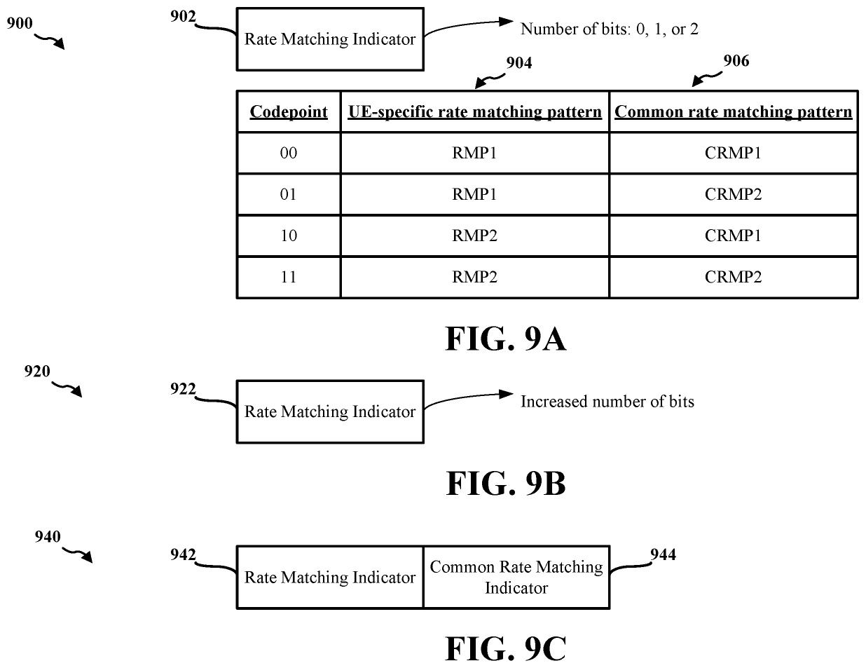

The network may indicate an active rate matching pattern of the common message for the co-scheduled UEs via DCI, such as the DCI 850. In some aspects, the network may use the rate matching indicator field of the DCI to signal the active rate matching pattern of the common message. FIG. 9A illustrates a portion of an example DCI 900 including a rate matching indicator field 902, as presented herein. The rate matching indicator field 902 may be 0 bits, 1 bit, or 2 bits long. In the example of FIG. 9A, the value of the rate matching indicator field 902 may determine the rate matching pattern of the common stream and the private stream at each UE. For example, each value of the rate matching indicator field 902 of the DCI 900 may determine a pair of rate matching patterns (e.g., a UE-specific rate matching pattern 904 and a common rate matching pattern 906).

In the illustrated example of FIG. 9A, the rate matching indicator field 902 has a size of 2 bits and, thus, four codepoints (e.g., values) may be represented. For example, a first codepoint “00” may indicate that the UE-specific rate matching pattern is a first rate matching pattern (“RMP1”) and that the common rate matching pattern is a first common rate matching pattern (“CRPM1”). A second codepoint “01” may indicate that the UE-specific rate matching pattern is the first rate matching pattern (“RMP1”) and that the common rate matching pattern is a second common rate matching pattern (“CRPM2”). A third codepoint “10” may indicate that the UE-specific rate matching pattern is a second rate matching pattern (“RMP2”) and that the common rate matching pattern is the first common rate matching pattern (“CRPM1”). A fourth codepoint “11” may indicate that the UE-specific rate matching pattern is the second rate matching pattern (“RMP2”) and that the common rate matching pattern is the second common rate matching pattern (“CRPM2”).

In some examples, the UE-specific rate matching pattern 904 and the common rate matching pattern 906 may be indicated from a set of respective rate matching patterns. For example, the UE-specific rate matching pattern 904 may be included in a set of rate matching patterns configured by the rate matching pattern configuration 810 of FIG. 8. Additionally, or alternatively, the common rate matching pattern 906 may be included in a set of common rate matching patterns configured by the common rate matching pattern configuration 820 of FIG. 8.

Although the size of the rate matching indicator field 902 of FIG. 9A is two bits, in other examples, the size of the rate matching indicator field may be 0 bits or 1 bit, as described in connection with the rate matching indicator field 604 of FIG. 6. For example, the size of the rate matching indicator field 902 may be based on the maximum number of defined rate matching patterns for the common stream and the private stream. However, it may be appreciated that such a limitation on the size of the rate matching indicator field 902 may also limit the number of defined rate matching patterns.

FIG. 9B illustrates a portion of an example DCI 920 including a rate matching indicator field 922, as presented herein. In the illustrated example of FIG. 9B, the size of the rate matching indicator field 922 may be increased compared to the rate matching indicator field 902 of FIG. 9A. For example, the size of the rate matching indicator field 922 may be more than two bits, such as three bits, four bits, etc. Similar to the example of FIG. 9A, the value of the rate matching indicator field 922 may determine the rate matching pattern of the common stream and the private stream at each UE. For example, each codepoint of the rate matching indicator field 922 of the DCI 920 may determine a pair of rate matching patterns (e.g., a UE-specific rate matching pattern and a common rate matching pattern). It may be appreciated that with a larger size allocated to the rate matching indicator field 922, the number of rate matching patterns that may be indicated by the codepoint also increases. It may also be appreciated that with a larger size allocated to the rate matching indicator field 922, the size of the DCI 920 may also increase.

In some aspects, instead of reusing the rate matching indicator field of a DCI to indicate the common rate matching pattern and the UE-specific rate matching pattern, techniques disclosed herein may introduce a new field in the DCI to communicate the active rate matching pattern of the common stream.

FIG. 9C illustrates a portion of an example DCI 940 including a rate matching indicator field 942 and a common rate matching indicator field 944, as presented herein. In the illustrated example of FIG. 9C, the value of the rate matching indicator field 942 may indicate a UE-specific rate matching pattern of the private stream. Additionally, the value of the common rate matching indicator field 944 may indicate a common rate matching pattern of the common stream. It may be appreciated that adding the common rate matching indicator field 944 to the DCI may also increase the size of the DCI.

Returning to the example of FIG. 8, the UE 804 may determine the common rate matching information 854 and the UE-specific rate matching information 858 based on the different techniques to indicate the active rate matching patterns via the DCI. For example, the DCI may include a rate matching indicator field with a value that maps to a pair of rate matching patterns, as described in connection with the examples of FIG. 9A and FIG. 9B. For example, the UE 804 may receive a joint indication (e.g., the codeword of FIG. 9A) that indicates the UE-specific rate matching pattern 904 and the common rate matching pattern 906 of FIG. 9A. The UE 804 may determine, via the determination procedure 852, that the common rate matching information 854 includes the common rate matching pattern 906 of FIG. 9A. Additionally, the UE 804 may determine, via the determination procedure 856, that the UE-specific rate matching information 858 includes the UE-specific rate matching pattern 904 of FIG. 9A. Additionally, or alternatively, the pair of the common rate matching pattern and the UE-specific rate matching pattern may be indicated from a set of rate matching patterns, such as a first set of rate matching patterns configured via the rate matching pattern configuration 810 and a second set of common rate matching patterns configured via the common rate matching pattern configuration 820.

In examples in which the DCI includes a rate matching indicator field and a common rate matching indicator field, as described in connection with the example of FIG. 9C, the UE 804 may determine the UE-specific rate matching pattern via the value of the rate matching indicator field. The UE 804 may also determine the common rate matching pattern via the value of the common rate matching indicator field. It may be appreciated that the indicated UE-specific rate matching pattern and/or the common rate matching pattern may be indicated from respective sets of rate matching patterns.

As described above, in addition to aligning the rate matching patterns for the common message across co-scheduled UEs, it may also be beneficial to align the non-ZP CSI configurations and the ZP CSI configurations. Aspects disclosed herein facilitate configuring a new configuration for non-ZP CSI associated with the common stream of a rate-splitting MU-MIMO communication. For example, the network may provide a new non-ZP CSI configuration that is shared between the co-scheduled UEs of a rate-splitting MU-MIMO communication. The new non-ZP CSI configuration, which may be referred to as a “NZP-CSI-RS-ResourceSetCommon” parameter or by any other suitable name, may be configured and/or updated via RRC signaling and/or a MAC-CE.

Referring again to the example of FIG. 8, the network entity 802 may provide a non-ZP CSI configuration 840 that is received by the UE 804. The network entity 802 may provide the non-ZP CSI configuration 840 via RRC signaling and/or a MAC-CE. The non-ZP CSI configuration 840 may configure a non-ZP CSI-RS resource or resource set that is associated with a common stream (X_{c}) of a rate-splitting MU-MIMO communication, such as the common stream 432 of FIG. 4.

In some examples, when the UE 804 determines the common rate matching information 854 (e.g., via the determination procedure 852), the UE 804 may include the non-ZP CSI configuration 840 with the common rate matching pattern.

Similar to the no-ZP CSI configurations, it may be beneficial to align the ZP CSI configurations when used with the common stream. For example, aspects disclosed herein facilitate configuring a new configuration for ZP CSI associated with the common stream of a rate-splitting MU-MIMO communication. For example, the network may provide a new ZP CSI configuration that is shared between the co-scheduled UEs of a rate-splitting MU-MIMO communication. The new ZP CSI configuration, which may be referred to as a “ZP-CSI-RS-ResourceSetCommon” parameter or by any other suitable name, may be configured and/or updated via RRC signaling and/or a MAC-CE.

In the illustrated example of FIG. 8, the network entity 802 may provide a ZP CSI configuration 842 that is received by the UE 804. The network entity 802 may provide the ZP CSI configuration 842 via RRC signaling and/or a MAC-CE. The ZP CSI configuration 842 may configure a ZP CSI-RS resource or resource set that is associated with a common stream (X_{c}) of a rate-splitting MU-MIMO communication, such as the common stream 432 of FIG. 4.

As described above, aperiodic ZP CSI-RS may be triggered, for example, by a ZP CSI-RS trigger field, such as the ZP CSI-RS trigger field 606 of FIG. 6. The ZP CSI-RS trigger field may indicate an active aperiodic ZP CSI-RS resource set. The network may indicate an active aperiodic ZP CSI-RS resource set for the comment stream for the co-scheduled UEs via DCI, such as the DCI 850.

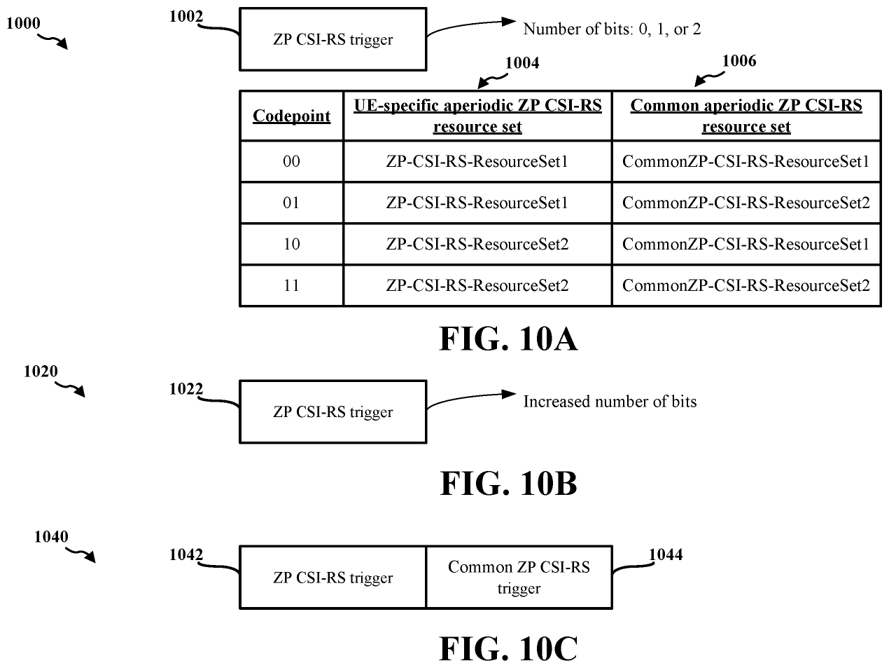

In some aspects, the network may use the ZP CSI-RS trigger field of the DCI to signal the active aperiodic ZP CSI-RS resource set for the common stream. FIG. 10A illustrates a portion of an example DCI 1000 including a ZP CSI-RS trigger field 1002, as presented herein. The ZP CSI-RS trigger field 1002 may be 0 bits, 1 bit, or 2 bits long. In the example of FIG. 10A, the value of the ZP CSI-RS trigger field 1002 may determine the aperiodic ZP CSI-RS resource set of the common stream and the private stream at each UE. For example, each value of the ZP CSI-RS trigger field 1002 of the DCI 1000 may determine a pair of aperiodic ZP CSI-RS resource sets (e.g., a UE-specific aperiodic ZP CSI-RS resource set 1004 and a common aperiodic ZP CSI-RS resource set 1006).

In the illustrated example of FIG. 10A, the ZP CSI-RS trigger field 1002 has a size of 2 bits and, thus, four codepoints (e.g., values) may be represented. For example, a first codepoint “00” may indicate that the UE-specific aperiodic ZP CSI-RS resource set is a first aperiodic ZP CSI-RS resource set (“ZP-CSI-RS-ResourceSet1”) and that the common aperiodic ZP CSI-RS resource set is a first common aperiodic ZP CSI-RS resource set (“CommonZP-CSI-RS-ResourceSet1”). A second codepoint “01” may indicate that the UE-specific aperiodic ZP CSI-RS resource set is the first aperiodic ZP CSI-RS resource set (“ZP-CSI-RS-ResourceSet1”) and that the common aperiodic ZP CSI-RS resource set is a second common aperiodic ZP CSI-RS resource set (“CommonZP-CSI-RS-ResourceSet2”). A third codepoint “10” may indicate that the UE-specific aperiodic ZP CSI-RS resource set is a second aperiodic ZP CSI-RS resource set (“ZP-CSI-RS-ResourceSet2”) and that the common aperiodic ZP CSI-RS resource set is the first common aperiodic ZP CSI-RS resource set (“CommonZP-CSI-RS-ResourceSet1”). A fourth codepoint “11” may indicate that the UE-specific aperiodic ZP CSI-RS resource set is the second aperiodic ZP CSI-RS resource set (“ZP-CSI-RS-ResourceSet2”) and that the common aperiodic ZP CSI-RS resource set is the second common aperiodic ZP CSI-RS resource set (“CommonZP-CSI-RS-ResourceSet2”).

In some examples, the UE-specific aperiodic ZP CSI-RS resource set 1004 and the common aperiodic ZP CSI-RS resource set 1006 may be indicated from a set of respective aperiodic ZP CSI-RS resource sets. For example, the UE-specific aperiodic ZP CSI-RS resource set 1004 and/or the common aperiodic ZP CSI-RS resource set 1006 may be included in a set of common aperiodic ZP CSI-RS resource sets configured by the non-ZP CSI configuration 840 of FIG. 8

Although the size of the ZP CSI-RS trigger field 1002 of FIG. 10A is two bits, in other examples, the size of the ZP CSI-RS trigger field may be 0 bits or 1 bit, as described in connection with the ZP CSI-RS trigger field 606 of FIG. 6. For example, the size of the ZP CSI-RS trigger field 1002 may be based on the maximum number of defined aperiodic ZP CSI-RS resource sets for the common stream and the private stream. However, it may be appreciated that such a limitation on the size of the ZP CSI-RS trigger field 1002 may also limit the number of defined aperiodic ZP CSI-RS resource sets.

FIG. 10B illustrates a portion of an example DCI 1020 including a ZP CSI-RS trigger field 1022, as presented herein. In the illustrated example of FIG. 10B, the size of the ZP CSI-RS trigger field 1022 may be increased compared to the ZP CSI-RS trigger field 1002 of FIG. 10A. For example, the size of the ZP CSI-RS trigger field 1022 may be more than two bits, such as three bits, four bits, etc. Similar to the example of FIG. 10A, the value of the ZP CSI-RS trigger field 1022 may determine the aperiodic ZP CSI-RS resource set of the common stream and the private stream at each UE. For example, each codepoint of the ZP CSI-RS trigger field 1022 of the DCI 1020 may determine a pair of aperiodic ZP CSI-RS resource sets (e.g., a UE-specific aperiodic ZP CSI-RS resource set and a common aperiodic ZP CSI-RS resource set). It may be appreciated that with a larger size allocated to the ZP CSI-RS trigger field 1022, the number of aperiodic ZP CSI-RS resource sets that may be indicated by the codepoint also increases. It may also be appreciated that with a larger size allocated to the ZP CSI-RS trigger field 1022, the size of the DCI 1020 may also increase.

In some aspects, instead of reusing the ZP CSI-RS trigger field of a DCI to indicate the common aperiodic ZP CSI-RS resource set and the UE-specific aperiodic ZP CSI-RS resource set, techniques disclosed herein may introduce a new field in the DCI to communicate the active aperiodic ZP CSI-RS resource set of the common stream.

FIG. 10C illustrates a portion of an example DCI 1040 including a ZP CSI-RS trigger field 1042 and a common ZP CSI-RS trigger field 1044, as presented herein. In the illustrated example of FIG. 10C, the value of the ZP CSI-RS trigger field 1042 may indicate a UE-specific aperiodic ZP CSI-RS resource set of the private stream. Additionally, the value of the common ZP CSI-RS trigger field 1044 may indicate a common aperiodic ZP CSI-RS resource set of the common stream. It may be appreciated that adding the common ZP CSI-RS trigger field 1044 to the DCI may also increase the size of the DCI.

Returning to the example of FIG. 8, the UE 804 may determine the common rate matching information 854 and the UE-specific rate matching information 858 based on the different techniques to indicate the aperiodic ZP CSI-RS resource set via the DCI. For example, the DCI may include a ZP CSI-RS trigger field with a value that maps to a pair of aperiodic ZP CSI-RS resource sets, as described in connection with the examples of FIG. 10A and FIG. 10B. For example, the UE 804 may receive a joint indication (e.g., the codeword of FIG. 10A) that indicates the UE-specific aperiodic ZP CSI-RS resource set 1004 and the common aperiodic ZP CSI-RS resource set 1006 of FIG. 10A. The UE 804 may determine, via the determination procedure 852, that the common rate matching information 854 includes the common aperiodic ZP CSI-RS resource set 1006 of FIG. 10A. Additionally, the UE 804 may determine, via the determination procedure 856, that the UE-specific rate matching information 858 includes the UE-specific aperiodic ZP CSI-RS resource set 1004 of FIG. 10A. Additionally, or alternatively, the pair of the common aperiodic ZP CSI-RS resource set and the UE-specific aperiodic ZP CSI-RS resource set may be indicated from a set of aperiodic ZP CSI-RS resource sets, such as a set of aperiodic ZP CSI-RS resource sets configured via the ZP CSI configuration 842.

In examples in which the DCI includes a ZP CSI-RS trigger field and a common ZP CSI-RS trigger field, as described in connection with the example of FIG. 10C, the UE 804 may determine the UE-specific aperiodic ZP CSI-RS resource set via the value of the ZP CSI-RS trigger field. The UE 804 may also determine the common aperiodic ZP CSI-RS resource set via the value of the common ZP CSI-RS trigger field. It may be appreciated that the indicated UE-specific aperiodic ZP CSI-RS resource set and/or the common aperiodic ZP CSI-RS resource set may be indicated from respective sets of aperiodic ZP CSI-RS resource sets.

In some aspects, to provide unified rate matching patterns and CSI configurations for the common message, techniques disclosed herein utilize a same rate matching pattern and CSI configuration for a common codeword (“c-cw”) and a private codeword (“p-cw”). For example, the network may provide rate-splitting rate match information that may be defined for rate-splitting communications, such as rate-splitting MU-MIMO communications. The rate-splitting rate match information may define new rate matching patterns and CSI configurations. In some examples, a UE receiving the rate-splitting rate match information may apply the new rate matching patterns and CSI configurations for the common codeword and the private codeword.

For example, and referring again to the example of FIG. 8, the network entity 802 may provide rate-splitting rate match information 830 that is received by the UE 804. The network entity 802 may provide the rate-splitting rate match information via RRC signaling and/or a MAC-CE. The rate-splitting rate match information 830 may configure one or more rate match patterns and CSI configurations at the UE 804. The UE 804 may use the rate match patterns and CSI configurations of the rate-splitting rate match information 830 to decode the common codeword (e.g., via the decoding procedure 870) and to decode the private codeword (e.g., via the decoding procedure 872) of the rate-splitting MU-MIMO communication 860. In some such examples, the common rate matching information 854 and the UE-specific rate matching information 858 may be the same rate matching patterns and CSI configurations.

In some examples, the UE 804 may be configured with a set of rate-splitting rate match information. For example, the rate-splitting rate match information 830 may configure first rate-splitting rate match information 832 (“RSRM1”) and second rate-splitting rate match information 834 (“RSRM2”). In some examples, the DCI 850 may indicate which of the rate-splitting rate match information at the UE 804 is the active rate-splitting rate match information.

In some aspects disclosed herein, the network may configure the co-scheduled UEs to have different configurations for non-ZP CSI and ZP CSI. In some such examples, the network may align the rate matching across the different UEs by jointly designing the non-ZP CSI pattern and the ZP CSI pattern at the different UEs. For example, a first UE may be configured for a non-ZP CSI-RS with a resource allocation for a first resource. A second UE may be configured for a ZP CSI-RS with a resource allocation for the same first resource. In some such examples, both UEs may rate match around the first resource for receiving a rate-splitting MU-MIMO communication. However, the first UE may use the first resource for performing measurements, while the second UE may ignore the first resource.

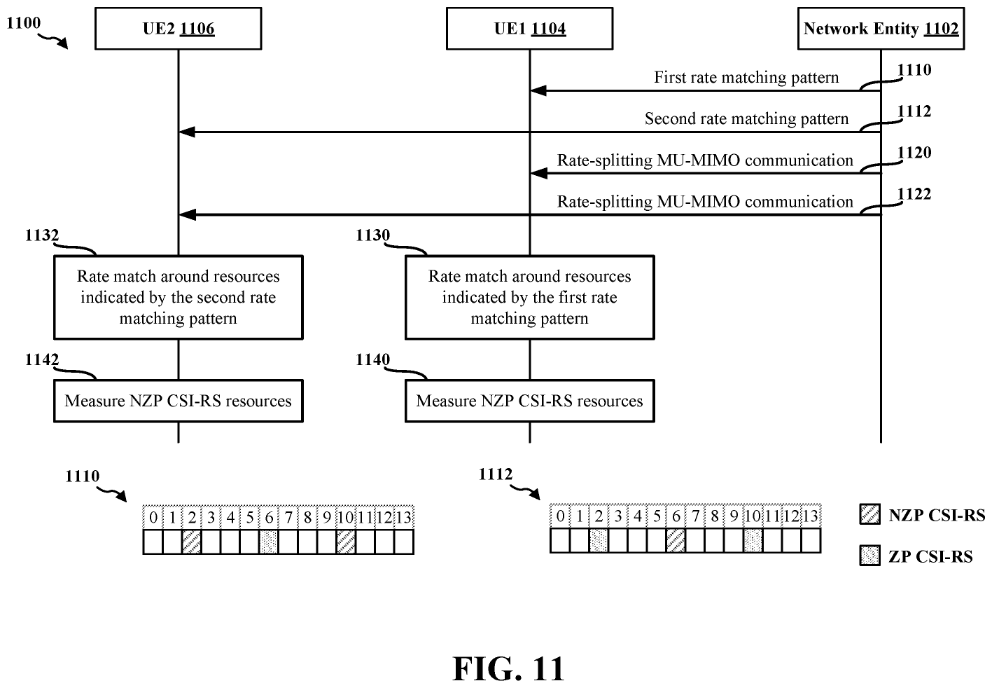

FIG. 11 illustrates an example communication flow 1100 between a network entity 1102, a first UE 1104 (“UE1”), and a second UE 1106 (“UE2”), as presented herein. One or more aspects described for the network entity 1102 may be performed by a component of a base station or a network entity, such as a CU, a DU, and/or an RU. In the illustrated example, the communication flow 1100 enables the network entity 1102 provide co-scheduled UEs with different configurations for non-ZP CSI and ZP CSI that are also aligned, which may increase spectral efficiency, capability, data rates, and/or reliability associated with rate-splitting MU-MIMO communications. Aspects of the network entity 1102 may be implemented by the base station 102 of FIG. 1 and/or the base station 310 of FIG. 3. Aspects of the first UE 1104 and/or the second UE 1106 may be implemented by the UE 104 of FIG. 1 and/or the UE 350 of FIG. 3. Although not shown in the illustrated example of FIG. 11, in additional or alternative examples, the network entity 1102, the first UE 1104, and/or the second UE 1106 may be in communication with one or more other base stations or UEs.

In the illustrated example of FIG. 11, the network entity 1102 configures the first UE 1104 and the second UE 1106 with respective rate matching patterns. For example, the network entity 1102 may provide a first rate matching pattern 1110 that is received by the first UE 1104. Additionally, the network entity 1102 may provide a second rate matching pattern 1112 that is received by the second UE 1106. The network entity 1102 may provide the respective rate matching patterns via RRC signaling.

In the illustrated example of FIG. 11, the rate matching patterns identify resources associated with a non-ZP CSI configuration and a ZP CSI-RS configuration. For example, the first rate matching pattern 1110 indicates a CSI-RS configuration in which a third resource and an eleventh resource are allocated to non-ZP CSI-RS, and a seventh resource is allocated to ZP CSI-RS. The second rate matching pattern 1112 indicates a CSI-RS configuration in which the third resource and the eleventh resource are allocated to ZP CSI-RS, and the seventh resource is allocated to non-ZP CSI-RS. As shown in FIG. 11, the first rate matching pattern 1110 and the second rate matching pattern 1112 are aligned with respect to the locations of CSI-RS.

In the illustrated example of FIG. 11, the network entity 1102 provides a rate-splitting MU-MIMO communication to the first UE 1104 and the second UE 1106. For example, the network entity 1102 may provide a first rate-splitting MU-MIMO communication 1120 that is received by the first UE 1104. The network entity 1102 may also provide a second rate-splitting MU-MIMO communication 1122 that is received by the second UE 1106. The first rate-splitting MU-MIMO communication 1120 and the second rate-splitting MU-MIMO communication 1122 may include the same information. For example, the first rate-splitting MU-MIMO communication 1120 and the second rate-splitting MU-MIMO communication 1122 may each include a common codeword that is common to the first UE 1104 and the second UE 1106. Aspects of the first rate-splitting MU-MIMO communication 1120 and the second rate-splitting MU-MIMO communication 1122 may be similar to the rate-splitting MU-MIMO communication 460 of FIG. 4 and the rate-splitting MU-MIMO communication 510 of FIG. 5.

As shown in FIG. 11, the first UE 1104 and the second UE 1106 may rate match around resources indicated by their respective rate matching patterns. For example, the first UE 1104 may perform a rate matching procedure 1130 to rate match around resources indicated by the first rate matching pattern 1110. Similarly, the second UE 1106 may perform a rate matching procedure 1132 to rate match around resources indicated by the second rate matching pattern 1112. In the example of FIG. 11, the first UE 1104 and the second UE 1106 may rate match around the third resource, the seventh resource, and the eleventh resource.

In some examples, the UEs may be configured to perform measurements on resources associated with non-ZP CSI-RSs. For example, the first UE 1104 may perform a measurement procedure 1140 to perform measurements at the third resource and the eleventh resource based on the locations of the non-ZP CSI-RS indicated by the first rate matching pattern 1110. Similarly, the second UE 1106 may perform a measurement procedure 1142 to perform measurements at the seventh resource based on the location of the non-ZP CSI-RS indicated by the second rate matching pattern 1112.

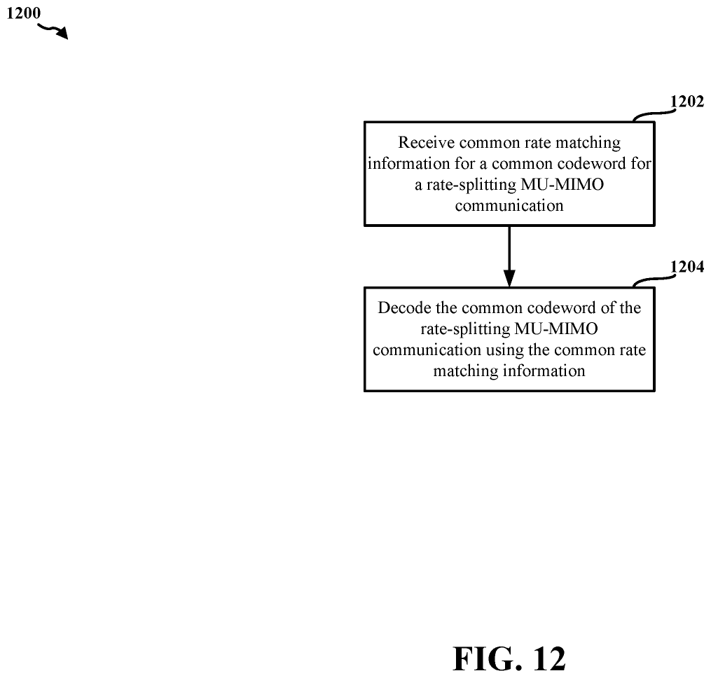

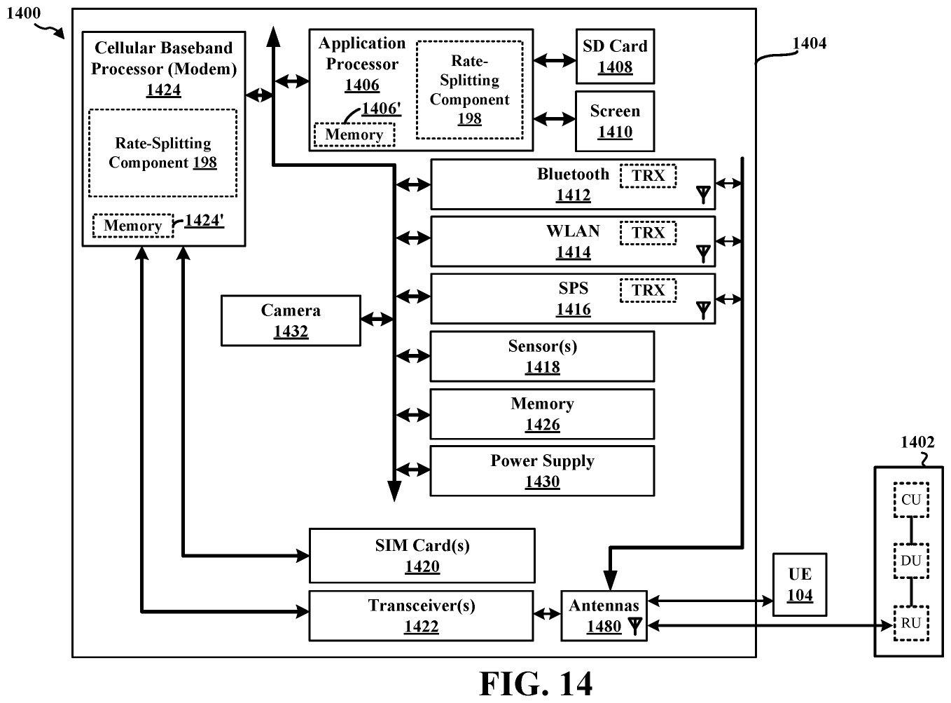

FIG. 12 is a flowchart 1200 of a method of wireless communication. The method may be performed by a UE (e.g., the UE 104, and/or an apparatus 1404 of FIG. 14). The method may facilitate improving spectral efficiency and reliability associated with rate-splitting MU-MIMO communications by aligning rate matching patterns across co-scheduled UEs for the common stream of the rate-splitting MU-MIMO communications.

At 1202, the UE receives common rate matching information for a common codeword for a rate-splitting MU-MIMO communication, as described in connection with at least the common rate matching information 854 of FIG. 8. The receiving of the common rate matching information, at 1202, may be performed by a cellular RF transceiver 1422/the rate-splitting component 198 of the apparatus 1404 of FIG. 14.

At 1204, the UE decodes the common codeword of the rate-splitting MU-MIMO communication using the common rate matching information, as described in connection with at least the decoding procedure 870 of FIG. 8. The decoding of the common codeword, at 1204, may be performed by the rate-splitting component 198 of the apparatus 1404 of FIG. 14.

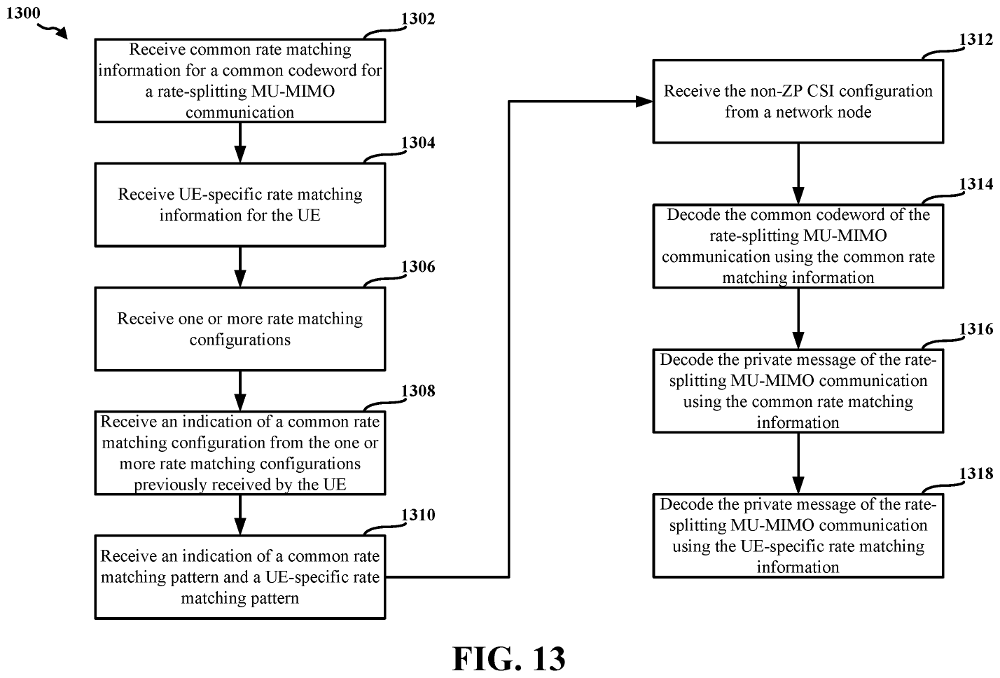

FIG. 13 is a flowchart 1300 of a method of wireless communication. The method may be performed by a UE (e.g., the UE 104, and/or an apparatus 1404 of FIG. 14). The method may facilitate improving spectral efficiency and reliability associated with rate-splitting MU-MIMO communications by aligning rate matching patterns across co-scheduled UEs for the common stream of the rate-splitting MU-MIMO communications.

At 1302, the UE receives common rate matching information for a common codeword for a rate-splitting MU-MIMO communication, as described in connection with at least the common rate matching information 854 of FIG. 8. In some examples, the common rate matching information may be included in one or more of an RRC message, a MAC-CE, or DCI. The receiving of the common rate matching information, at 1302, may be performed by a cellular RF transceiver 1422/the rate-splitting component 198 of the apparatus 1404 of FIG. 14.

At 1314, the UE decodes the common codeword of the rate-splitting MU-MIMO communication using the common rate matching information, as described in connection with at least decoding procedure 870 of FIG. 8. The decoding of the common codeword, at 1314, may be performed by the rate-splitting component 198 of the apparatus 1404 of FIG. 14.

In some examples, the common rate matching information (e.g., at 1302) may include a ZP CSI configuration that is common to UEs to which the rate-splitting MU-MIMO communication is directed, as described in connection with the ZP CSI configuration 842 of FIG. 8.

In some examples, the common rate matching information (e.g., at 1302) may include a non-ZP CSI configuration associated with a common message including the common codeword that is common to UEs to which the rate-splitting MU-MIMO communication is directed. In some such examples, the UE may receive, at 1312, the non-ZP CSI configuration from a network node, as described in connection with at least the non-ZP CSI configuration 840 of FIG. 8. The receiving of the non-ZP CSI configuration, at 1312, may be performed by the cellular RF transceiver 1422/the rate-splitting component 198 of the apparatus 1404 of FIG. 14.

In some examples, the rate-splitting MU-MIMO communication may include the common codeword that is common to multiple UEs and a private message for the UE, as described in connection with at least the rate-splitting MU-MIMO communication 460 of FIG. 4 and/or the rate-splitting MU-MIMO communication 510 of FIG. 5. In some such examples, the UE may decode, at 1316, the private message of the rate-splitting MU-MIMO communication using the common rate matching information, as described in connection with at least the rate-splitting rate match information 830 and the decoding procedure 872 of FIG. 8. The decoding of the private message, at 1316, may be performed by the rate-splitting component 198 of the apparatus 1404 of FIG. 14.

In other examples, the UE may receive, at 1304, UE-specific rate matching information for the UE, as described in connection with at least the UE-specific rate matching information 858 of FIG. 8 and/or the UE-specific rate matching pattern 904 of FIG. 9A. The receiving of the UE-specific rate matching information, at 1304, may be performed by the cellular RF transceiver 1422/the rate-splitting component 198 of the apparatus 1404 of FIG. 14.

At 1318, the UE may decode the private message of the rate-splitting MU-MIMO communication using the UE-specific rate matching information, as described in connection with at least the decoding procedure 872 of FIG. 8. The decoding of the private message, at 1318, may be performed by the rate-splitting component 198 of the apparatus 1404 of FIG. 14.

In some examples, to receive the common rate matching information (e.g., at 1302), the UE may receive, at 1306, one or more rate matching configurations, as described in connection with at least the rate matching pattern configuration 810 and the common rate matching pattern configuration 820 of FIG. 8. The receiving of the one or more rate matching configurations, at 1306, may be performed by the cellular RF transceiver 1422/the rate-splitting component 198 of the apparatus 1404 of FIG. 14.

Additionally, at 1308, the UE may receive an indication of a common rate matching configuration from the one or more rate matching configurations previously received by the UE, as described in connection with at least the codepoint of the rate matching indicator field 902 of FIG. 9A and/or the common rate matching indicator field 944 of FIG. 9C. The receiving of the indication of the common rate matching configuration, at 1308, may be performed by the cellular RF transceiver 1422/the rate-splitting component 198 of the apparatus 1404 of FIG. 14.

In some examples, to receive the common rate matching information, the UE may receive, at 1310, an indication of a common rate matching pattern and a UE-specific rate matching pattern.

For example, the UE may receive a joint indication that indicates the common rate matching pattern and the UE-specific rate matching pattern, as described in connection with at least the codepoint of the rate matching indicator field 902 of FIG. 9A and/or the rate matching indicator field 922 of FIG. 9B.

In other examples, the UE may receive a control message that includes a first indication of the common rate matching pattern and a second indication of the UE-specific rate matching pattern, as described in connection with at least the rate matching indicator field 942 and the common rate matching indicator field 944 of FIG. 9C.

In other examples, the common rate matching information may indicate a pair of the common rate matching pattern and the UE-specific rate matching pattern from a set of rate matching patterns, as described in connection with at least the DCI 850 and the rate matching patterns associated with the rate matching pattern configuration 810 and the common rate matching pattern configuration 820 of FIG. 8.

The receiving of the indication of the common rate matching pattern and the UE-specific rate matching pattern, at 1310, may be performed by the cellular RF transceiver 1422/the rate-splitting component 198 of the apparatus 1404 of FIG. 14.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers (e.g., a cellular RF transceiver 1422). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor 1424 communicates through transceiver(s) (e.g., the cellular RF transceiver 1422) via one or more antennas 1480 with the UE 104 and/or with an RU associated with a network entity 1402. The cellular baseband processor 1424 and the application processor 1406 may each include a computer-readable medium/memory, such as the on-chip memory 1424′, and the on-chip memory 1406′, respectively. The additional memory modules 1426 may also be considered a computer-readable medium/memory. Each computer-readable medium/memory (e.g., the on-chip memory 1424′, the on-chip memory 1406′, and/or the additional memory modules 1426) may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see the UE 350 of FIG. 3) and include the additional modules of the apparatus 1404.

As discussed supra, the rate-splitting component 198 is configured to receive common rate matching information for a common codeword for a rate-splitting MU-MIMO communication; and decode the common codeword of the rate-splitting MU-MIMO communication using the common rate matching information.

The rate-splitting component 198 may be within the cellular baseband processor 1424, the application processor 1406, or both the cellular baseband processor 1424 and the application processor 1406. The rate-splitting component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1404 may include a variety of components configured for various functions. For example, the rate-splitting component 198 may include one or more hardware components that perform each of the blocks of the algorithm in the flowcharts of FIG. 12 and/or FIG. 13.

In one configuration, the apparatus 1404, and in particular the cellular baseband processor 1424 and/or the application processor 1406, includes means for receiving common rate matching information for a common codeword for a rate-splitting MU-MIMO communication. The example apparatus 1404 also includes means for decoding the common codeword of the rate-splitting MU-MIMO communication using the common rate matching information.

In another configuration, the example apparatus 1404 also includes means for receiving UE-specific rate matching information for the UE. The example apparatus 1404 also includes means for decoding the private message of the rate-splitting MU-MIMO communication using the UE-specific rate matching information.

In another configuration, the example apparatus 1404 also includes means for decoding the private message of the rate-splitting MU-MIMO communication using the common rate matching information.

In another configuration, the example apparatus 1404 also includes means for receiving one or more rate matching configurations. The example apparatus 1404 also includes means for receiving an indication of a common rate matching configuration from the one or more rate matching configurations previously received by the UE.

In another configuration, the example apparatus 1404 also includes means for receiving a joint indication that indicates a common rate matching pattern and a UE-specific rate matching pattern.

In another configuration, the example apparatus 1404 also includes means for receiving a control message that comprises a first indication of a common rate matching pattern and a second indication of a UE-specific rate matching pattern.

In another configuration, the example apparatus 1404 also includes means for receiving the non-ZP CSI configuration from a network node.

The means may be the rate-splitting component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

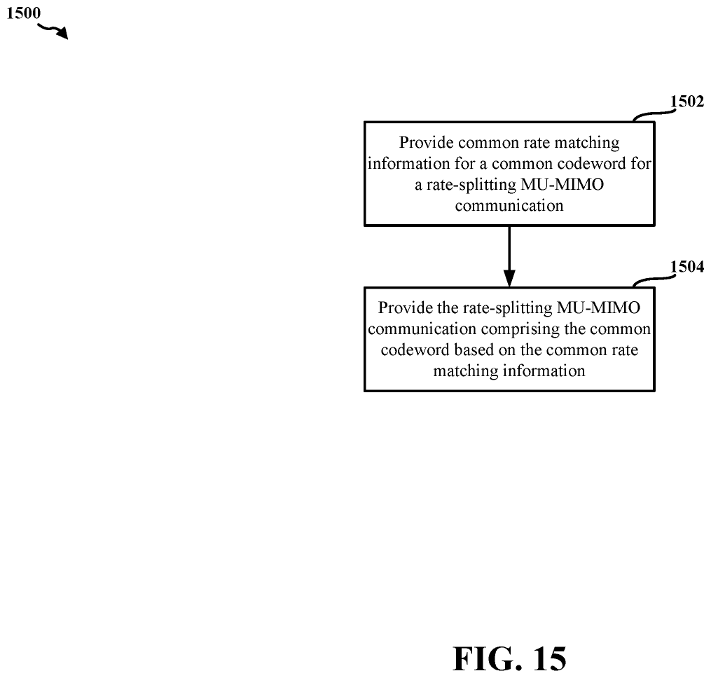

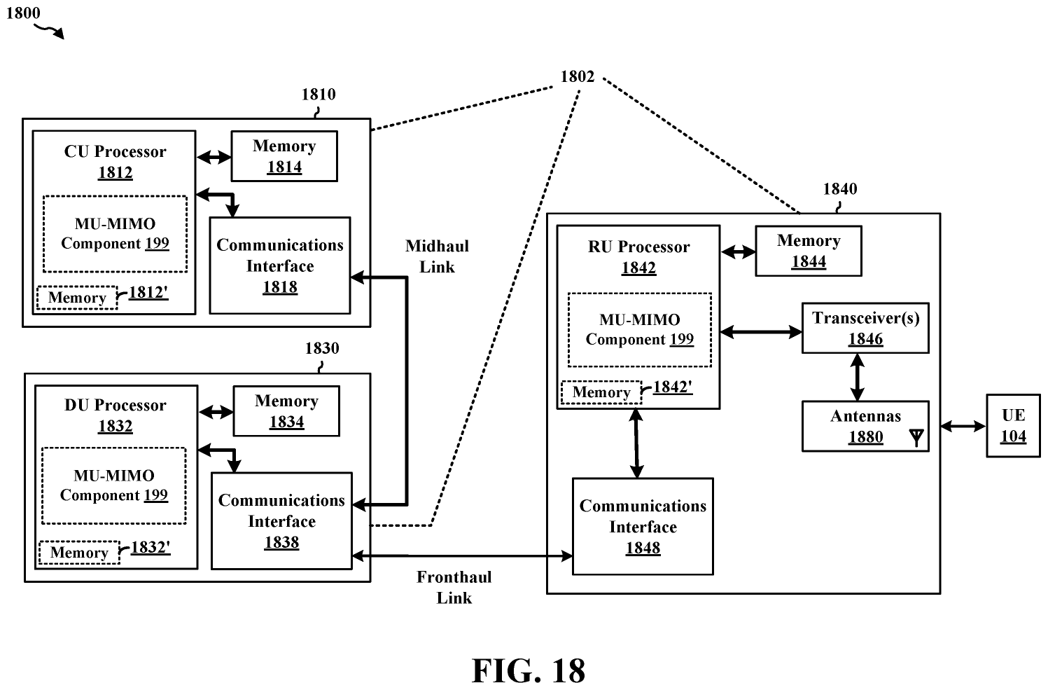

FIG. 15 is a flowchart 1500 of a method of wireless communication. The method may be performed by a network node (e.g., the base station 102, and/or a network entity 1802 of FIG. 18). The method may facilitate improving spectral efficiency and reliability associated with rate-splitting MU-MIMO communications by aligning rate matching patterns across co-scheduled UEs for the common stream of the rate-splitting MU-MIMO communications.

At 1502, the network node provides common rate matching information for a common codeword for a rate-splitting MU-MIMO communication, as described in connection with at least the common rate matching pattern configuration 820, the rate-splitting rate match information 830, the non-ZP CSI configuration 840, and/or the ZP CSI configuration 842 of FIG. 8. The providing of the common rate matching information, at 1502, may be performed by the MU-MIMO component 199 of the network entity 1802 of FIG. 18.

At 1504, the network node provides the rate-splitting MU-MIMO communication including the common codeword based on the common rate matching information, as described in connection with at least the rate-splitting MU-MIMO communication 860 of FIG. 8. The providing of the rate-splitting MU-MIMO communication, at 1504, may be performed by the MU-MIMO component 199 of the network entity 1802 of FIG. 18.

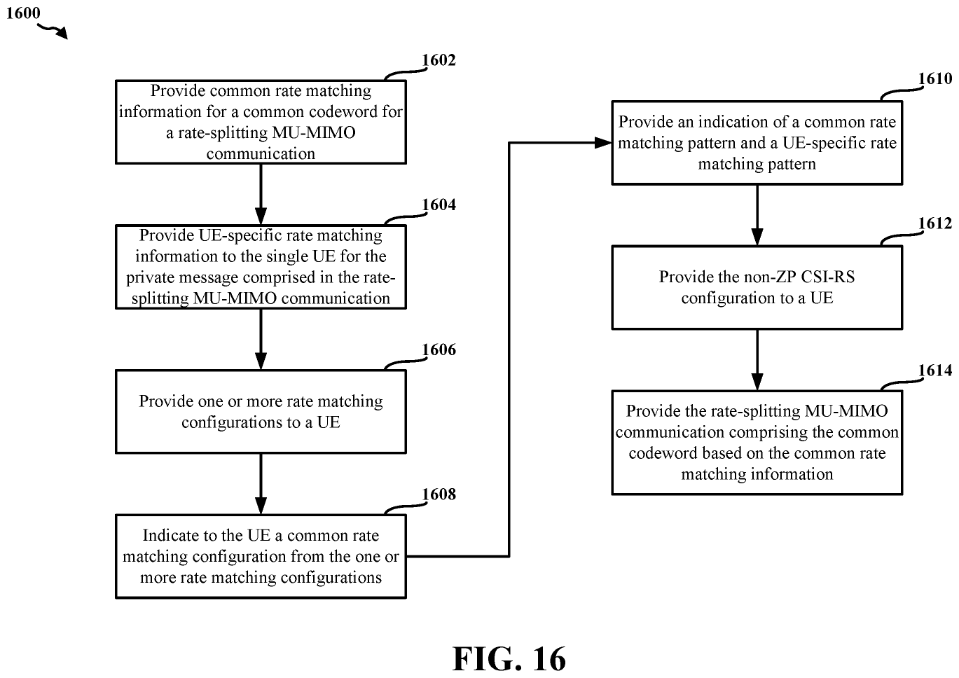

FIG. 16 is a flowchart 1600 of a method of wireless communication. The method may be performed by a network node (e.g., the base station 102, and/or a network entity 1802 of FIG. 18). The method may facilitate improving spectral efficiency and reliability associated with rate-splitting MU-MIMO communications by aligning rate matching patterns across co-scheduled UEs for the common stream of the rate-splitting MU-MIMO communications.

At 1602, the network node provides common rate matching information for a common codeword for a rate-splitting MU-MIMO communication, as described in connection with at least the common rate matching pattern configuration 820, the rate-splitting rate match information 830, the non-ZP CSI configuration 840, and/or the ZP CSI configuration 842 of FIG. 8. In some examples, the common rate matching information may be included in one or more of an RRC message, a MAC-CE, or DCI. The providing of the common rate matching information, at 1602, may be performed by the MU-MIMO component 199 of the network entity 1802 of FIG. 18.

At 1614, the network node provides the rate-splitting MU-MIMO communication including the common codeword based on the common rate matching information, as described in connection with at least the rate-splitting MU-MIMO communication 860 of FIG. 8. The providing of the rate-splitting MU-MIMO communication, at 1614, may be performed by the MU-MIMO component 199 of the network entity 1802 of FIG. 18.

In some examples, the common rate matching information (e.g., at 1602) may include a ZP-CSI configuration that is common to UEs to which the rate-splitting MU-MIMO communication is directed, as described in connection with the ZP CSI configuration 842 of FIG. 8.

In some examples, the common rate matching information (e.g., at 1602) may include a non-ZP CSI configuration associated with a common message including the common codeword that is common to UEs to which the rate-splitting MU-MIMO communication is directed. In some such examples, the network node may provide, at 1612, the non-ZP CSI configuration to a UE, as described in connection with at least the non-ZP CSI configuration 840 of FIG. 8. The providing of the non-ZP CSI configuration, at 1612, may be performed by the MU-MIMO component 199 of the network entity 1802 of FIG. 18.

In some examples, the rate-splitting MU-MIMO communication (e.g., at 1614) may include the common codeword that is common to multiple UEs and a private message for a single UE, as described in connection with at least the rate-splitting MU-MIMO communication 460 of FIG. 4 and/or the rate-splitting MU-MIMO communication 510 of FIG. 5. In some such examples, the common codeword and the private message may be rate matched based on the common rate matching information, as described in connection with at least the rate-splitting rate match information 830 and the decoding procedure 872 of FIG. 8.

In other examples, the network node may provide, at 1604, UE-specific rate matching information to the single UE for the private message included in the rate-splitting MU-MIMO communication, as described in connection with at least the UE-specific rate matching information 858 of FIG. 8 and/or the UE-specific rate matching pattern 904 of FIG. 9A. The providing of the UE-specific rate matching information, at 1604, may be performed by the MU-MIMO component 199 of the network entity 1802 of FIG. 18.

In some examples, to provide the common rate matching information (e.g., at 1602), the network node may provide, at 1606, one or more rate matching configurations to a UE, as described in connection with at least the rate matching pattern configuration 810 and the common rate matching pattern configuration 820 of FIG. 8. The providing of the one or more rate matching configurations, at 1606, may be performed by the MU-MIMO component 199 of the network entity 1802 of FIG. 18.

Additionally, at 1608, the network node may indicate to the UE a common rate matching configuration from the one or more rate matching configurations, as described in connection with at least the codepoint of the rate matching indicator field 902 of FIG. 9A and/or the common rate matching indicator field 944 of FIG. 9C. The indicating of the common rate matching configuration, at 1608, may be performed by the MU-MIMO component 199 of the network entity 1802 of FIG. 18.

In some examples, to provide the common rate matching information, the network node may provide, at 1610, an indication of a common rate matching pattern and a UE-specific rate matching pattern.

For example, the network node may provide a joint indication that indicates the common rate matching pattern and the UE-specific rate matching pattern, as described in connection with at least the codepoint of the rate matching indicator field 902 of FIG. 9A and/or the rate matching indicator field 922 of FIG. 9B.

In other examples, the network node may provide a control message that includes a first indication of the common rate matching pattern and a second indication of the UE-specific rate matching pattern, as described in connection with at least the rate matching indicator field 942 and the common rate matching indicator field 944 of FIG. 9C.

In other examples, the common rate matching information may indicate a pair of the common rate matching pattern and the UE-specific rate matching pattern from a set of rate matching patterns, as described in connection with at least the DCI 850 and the rate matching patterns associated with the rate matching pattern configuration 810 and the common rate matching pattern configuration 820 of FIG. 8.

The providing of the indication of the common rate matching pattern and the UE-specific rate matching pattern, at 1610, may be performed by the MU-MIMO component 199 of the network entity 1802 of FIG. 18.

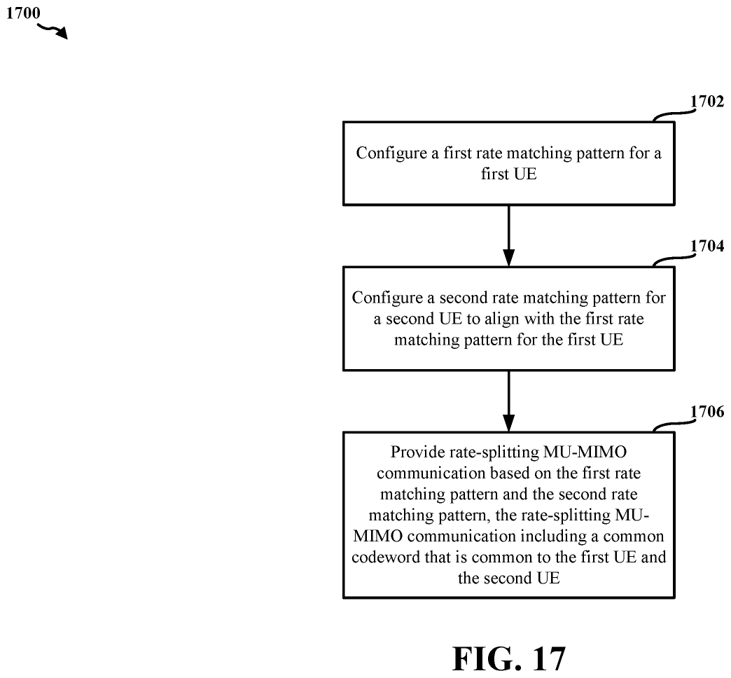

FIG. 17 is a flowchart 1700 of a method of wireless communication. The method may be performed by a network node (e.g., the base station 102, and/or a network entity 1802 of FIG. 18). The method may facilitate improving spectral efficiency and reliability associated with rate-splitting MU-MIMO communications by aligning rate matching patterns across co-scheduled UEs for the common stream of the rate-splitting MU-MIMO communications.

At 1702, the network node configures a first rate matching pattern for a first UE, as described in connection with at least the first rate matching pattern 1110 of FIG. 11. The configuring of the first rate matching pattern, at 1702, may be performed by the MU-MIMO component 199 of the network entity 1802 of FIG. 18.

At 1704, the network node configures a second rate matching pattern for a second UE to align with the first rate matching pattern for the first UE, as described in connection with at least the second rate matching pattern 1112 of FIG. 11. The configuring of the second rate matching pattern, at 1704, may be performed by the MU-MIMO component 199 of the network entity 1802 of FIG. 18.

At 1706, the network node provides a rate-splitting MU-MIMO communication based on the first rate matching pattern and the second rate matching pattern, as described in connection with at least the first rate-splitting MU-MIMO communication 1120 and the second rate-splitting MU-MIMO communication 1122 of FIG. 11. The rate-splitting MU-MIMO communication may include a common codeword that is common to the first UE and the second UE. The providing of the rate-splitting MU-MIMO communication, at 1706, may be performed by the MU-MIMO component 199 of the network entity 1802 of FIG. 18.

In some examples, the first rate matching pattern (e.g., at 1702) may include at least one of a first non-ZP CSI-RS configuration or a first ZP CSI-RS configuration, and the second rate matching pattern (e.g., at 1704) may include at least one of a second non-ZP CSI-RS configuration or a second ZP CSI-RS configuration, as described in connection with the first rate matching pattern 1110 and the second rate matching pattern 1112 of FIG. 11.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the MU-MIMO component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memories (e.g., the on-chip memory 1812′, the on-chip memory 1832′, and/or the on-chip memory 1842′) and/or the additional memory modules (e.g., the additional memory modules 1814, the additional memory modules 1834, and/or the additional memory modules 1844) may each be considered a computer-readable medium/memory. Each computer-readable medium/memory may be non-transitory. Each of the CU processor 1812, the DU processor 1832, the RU processor 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MU-MIMO component 199 is configured to provide common rate matching information for a common codeword for a rate-splitting MU-MIMO communication; and provide the rate-splitting MU-MIMO communication comprising the common codeword based on the common rate matching information.

Additionally, or alternatively, and as discussed supra, the MU-MIMO component 199 is configured to configure a first rate matching pattern for a first UE; configure a second rate matching pattern for a second UE to align with the first rate matching pattern for the first UE; and provide rate-splitting MU-MIMO communication based on the first rate matching pattern and the second rate matching pattern, the rate-splitting MU-MIMO communication including a common codeword that is common to the first UE and the second UE.

The MU-MIMO component 199 may be within one or more processors of one or more of the CU 1810, DU 1830, and the RU 1840. The MU-MIMO component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1802 may include a variety of components configured for various functions. For example, the MU-MIMO component 199 may include one or more hardware components that perform each of the blocks of the algorithm in the flowcharts of FIG. 15, FIG. 16, and/or FIG. 17.

In one configuration, the network entity 1802 includes means for providing common rate matching information for a common codeword for a rate-splitting MU-MIMO communication. The example network entity 1802 also includes means for providing the rate-splitting MU-MIMO communication comprising the common codeword based on the common rate matching information.

In another configuration, the example network entity 1802 also includes means for providing UE-specific rate matching information to the single UE for the private message comprised in the rate-splitting MU-MIMO communication.

In another configuration, the example network entity 1802 also includes means for providing one or more rate matching configurations to a UE. The example network entity 1802 also includes means for indicating to the UE a common rate matching configuration from the one or more rate matching configurations.

In another configuration, the example network entity 1802 also includes means for providing a joint indication that indicates a common rate matching pattern and a UE-specific rate matching pattern.

In another configuration, the example network entity 1802 also includes means for providing a control message that comprises a first indication of a common rate matching pattern and a second indication of a UE-specific rate matching pattern.

In another configuration, the example network entity 1802 also includes means for providing the non-ZP CSI-RS configuration to a UE.

In another configuration, the example network entity 1802 includes means for configuring a first rate matching pattern for a first UE. The example network entity 1802 also includes means for configuring a second rate matching pattern for a second UE to align with the first rate matching pattern for the first UE. The example network entity 1802 also includes means for providing rate-splitting MU-MIMO communication based on the first rate matching pattern and the second rate matching pattern, the rate-splitting MU-MIMO communication including a common codeword that is common to the first UE and the second UE.

The means may be the MU-MIMO component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

Aspects disclosed herein provide techniques for unifying rate matching patterns and CSI configurations for decoding common messages across co-scheduled UEs. In some aspects, separate rate matching patterns and CSI configurations may be configured for the common message (sometimes referred to herein as a “common codeword”) and the private message (sometimes referred to herein as a “private codeword”). In some aspects, co-scheduled UEs may be configured with rate-splitting rate match information that may include a same rate matching pattern and CSI configuration for the common message and the private message. For example, the rate matching pattern and the CSI configuration used to decode the common message may also be used to decode the private message of a rate-splitting MU-MIMO communication. In some aspects, the network may configure different configurations of non-ZP CSI and ZP CSI for co-scheduled UEs. In some such examples, the rate matching may be aligned between different UEs, for example, by designing the NZP CSI-RS pattern and the ZP CSI-RS pattern at the different co-scheduled UEs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving common rate matching information for a common codeword for a rate-splitting multiple user-multiple input multiple output (MU-MIMO) communication; and decoding the common codeword of the rate-splitting MU-MIMO communication using the common rate matching information.

Aspect 2 is the method of aspect 1, further including that the rate-splitting MU-MIMO communication includes the common codeword that is common to multiple UEs and a private codeword for the UE, the method further including: receiving UE-specific rate matching information for the UE; and decoding the private codeword of the rate-splitting MU-MIMO communication using the UE-specific rate matching information.

Aspect 3 is the method of aspect 1, further including that the rate-splitting MU-MIMO communication includes the common codeword that is common to multiple UEs and a private codeword for the UE, the method further including: decoding the private codeword of the rate-splitting MU-MIMO communication using the common rate matching information.

Aspect 4 is the method of any of aspects 1 to 3, further including that the common rate matching information is comprised in one or more of a radio resource control (RRC) message, a medium access control-control element (MAC-CE), or downlink control information (DCI).

Aspect 5 is the method of any of aspects 1 to 4, further including that receiving the common rate matching information includes: receiving one or more rate matching configurations; and receiving an indication of a common rate matching configuration from the one or more rate matching configurations previously received by the UE.

Aspect 6 is the method of any of aspects 1 to 4, further including that receiving the common rate matching information includes: receiving a joint indication that indicates a common rate matching pattern and a UE-specific rate matching pattern.

Aspect 7 is the method of any of aspects 1 to 4, further including that receiving the common rate matching information includes: receiving a control message that comprises a first indication of a common rate matching pattern and a second indication of a UE-specific rate matching pattern.

Aspect 8 is the method of any of aspects 1 to 7, further including that the common rate matching information indicates a pair of a common rate matching pattern and a UE-specific rate matching pattern from a set of rate matching pairs.

Aspect 9 is the method of any of aspects 1 to 8, further including that the common rate matching information includes a non-zero power channel state information reference signal (non-ZP CSI) configuration associated with a common message comprising the common codeword that is common to UEs to which the rate-splitting MU-MIMO communication is directed.

Aspect 10 is the method of aspect 9, further including: receiving the non-ZP CSI configuration from a network node.

Aspect 11 is the method of any of aspects 1 to 10, further including that the common rate matching information includes a zero power channel state information reference signal (ZP CSI) configuration that is common to UEs to which the rate-splitting MU-MIMO communication is directed.

Aspect 12 is an apparatus for wireless communication at a UE including at least one processor coupled to a memory and configured to implement any of aspects 1 to 11.

In aspect 13, the apparatus of aspect 12 further includes at least one antenna coupled to the at least one processor.

In aspect 14, the apparatus of aspect 12 or 13 further includes a transceiver coupled to the at least one processor.

Aspect 15 is an apparatus for wireless communication including means for implementing any of aspects 1 to 11.

In aspect 16, the apparatus of aspect 15 further includes at least one antenna coupled to the means to perform the method of any of aspects 1 to 11.

In aspect 17, the apparatus of aspect 15 or 16 further includes a transceiver coupled to the means to perform the method of any of aspects 1 to 11.

Aspect 18 is a non-transitory computer-readable storage medium storing computer executable code, where the code, when executed, causes a processor to implement any of aspects 1 to 11.

Aspect 19 is a method of wireless communication at a network node, including: providing common rate matching information for a common codeword for a rate-splitting multiple user-multiple input multiple output (MU-MIMO) communication; and providing the rate-splitting MU-MIMO communication comprising the common codeword based on the common rate matching information.

Aspect 20 is the method of aspect 19, further including that the rate-splitting MU-MIMO communication includes the common codeword that is common to multiple user equipment (UEs) and a private codeword for a single UE, the method further including: providing UE-specific rate matching information to the single UE for the private codeword comprised in the rate-splitting MU-MIMO communication.

Aspect 21 is the method of aspect 19, further including that the rate-splitting MU-MIMO communication includes the common codeword that is common to multiple user equipment (UEs) and a private codeword for a single UE, the common codeword and the private codeword being rate matched based on the common rate matching information.

Aspect 22 is the method of any of aspects 19 to 21, further including that the common rate matching information is comprised in one or more of a radio resource control (RRC) message, a medium access control-control element (MAC-CE), or downlink control information (DCI).

Aspect 23 is the method of any of aspects 19 to 22, further including that providing the common rate matching information includes: providing one or more rate matching configurations to a user equipment (UE); and indicating to the UE a common rate matching configuration from the one or more rate matching configurations.

Aspect 24 is the method of any of aspects 19 to 22, further including that providing the common rate matching information includes: providing a joint indication that indicates a common rate matching pattern and a user equipment (UE) specific rate matching pattern.

Aspect 25 is the method of any of aspects 19 to 22, further including that providing the common rate matching information includes: providing a control message that comprises a first indication of a common rate matching pattern and a second indication of a user equipment (UE) specific rate matching pattern.

Aspect 26 is the method of any of aspects 19 to 25, further including that the common rate matching information indicates a pair of a common rate matching pattern and a user equipment (UE) specific rate matching pattern from a set of rate matching pairs.

Aspect 27 is the method of any of aspects 19 to 26, further including that the common rate matching information includes a non-zero power channel state information reference signal (non-ZP CSI-RS) configuration associated with a common message comprising the common codeword that is common to user equipment (UEs) to which the rate-splitting MU-MIMO communication is directed.

Aspect 28 is the method of any of aspects 19 to 27, further including: providing the non-ZP CSI-RS configuration to a UE.

Aspect 29 is the method of any of aspects 19 to 28, further including that the common rate matching information includes a zero power channel state information reference signal (ZP CSI-RS) configuration that is common to user equipment (UEs) to which the rate-splitting MU-MIMO communication is directed.

Aspect 30 is an apparatus for wireless communication at a network node including at least one processor coupled to a memory and configured to implement any of aspects 19 to 29.

In aspect 31, the apparatus of aspect 30 further includes at least one antenna coupled to the at least one processor.

In aspect 32, the apparatus of aspect 30 or 31 further includes a transceiver coupled to the at least one processor.

Aspect 33 is an apparatus for wireless communication including means for implementing any of aspects 19 to 29.

In aspect 34, the apparatus of aspect 33 further includes at least one antenna coupled to the means to perform the method of any of aspects 19 to 29.

In aspect 35, the apparatus of aspect 33 or 34 further includes a transceiver coupled to the means to perform the method of any of aspects 19 to 29.

Aspect 36 is a non-transitory computer-readable storage medium storing computer executable code, where the code, when executed, causes a processor to implement any of aspects 19 to 29.

Aspect 37 is a method of wireless communication at a network node, including: configuring a first rate matching pattern for a first user equipment (UE); configuring a second rate matching pattern for a second UE to align with the first rate matching pattern for the first UE; and providing a rate-splitting multiple user-multiple input multiple output (MU-MIMO) communication based on the first rate matching pattern and the second rate matching pattern, the rate-splitting MU-MIMO communication including a common codeword that is common to the first UE and the second UE.

Aspect 38 is the method of aspect 37, further including that the first rate matching pattern comprises at least one of a first non-zero power channel state information reference signal (non-ZP CSI-RS) configuration or a first zero power channel state information reference signal (ZP CSI-RS) configuration, and the second rate matching pattern comprises at least one of a second non-ZP CSI-RS configuration or a second ZP CSI-RS configuration.

Aspect 39 is an apparatus for wireless communication at a network node including at least one processor coupled to a memory and configured to implement any of aspects 37 to 38.

In aspect 40, the apparatus of aspect 39 further includes at least one antenna coupled to the at least one processor.

In aspect 41, the apparatus of aspect 39 or 40 further includes a transceiver coupled to the at least one processor.

Aspect 42 is an apparatus for wireless communication including means for implementing any of aspects 37 to 38.

In aspect 43, the apparatus of aspect 42 further includes at least one antenna coupled to the means to perform the method of any of aspects 37 to 38.

In aspect 44, the apparatus of aspect 42 or 43 further includes a transceiver coupled to the means to perform the method of any of aspects 37 to 38.

Aspect 45 is a non-transitory computer-readable storage medium storing computer executable code, where the code, when executed, causes a processor to implement any of aspects 37 to 38.

What is claimed is:

1. An apparatus for wireless communication at a user equipment (UE), comprising:
a memory; and
at least one processor coupled to the memory and, based at least in part on information stored in the memory, the at least one processor is configured to:
receive common rate matching information for a common codeword for a rate-splitting multiple user-multiple input multiple output (MU-MIMO) communication; and
decode the common codeword of the rate-splitting MU-MIMO communication using the common rate matching information.

2. The apparatus of claim 1, wherein the rate-splitting MU-MIMO communication includes the common codeword that is common to multiple UEs and a private codeword for the UE, the at least one processor further configured to:
receive UE-specific rate matching information for the UE; and
decode the private codeword of the rate-splitting MU-MIMO communication using the UE-specific rate matching information.

3. The apparatus of claim 1, wherein the rate-splitting MU-MIMO communication includes the common codeword that is common to multiple UEs and a private codeword for the UE, the at least one processor further configured to:
decode the private codeword of the rate-splitting MU-MIMO communication using the common rate matching information.

4. The apparatus of claim 1, wherein to receive the common rate matching information, the at least one processor is configured to:
receive one or more rate matching configurations; and
receive an indication of a common rate matching configuration from the one or more rate matching configurations previously received by the UE.

5. The apparatus of claim 1, wherein the common rate matching information is comprised in one or more of a radio resource control (RRC) message, a medium access control-control element (MAC-CE), or downlink control information (DCI).

6. The apparatus of claim 1, wherein to receive the common rate matching information, the at least one processor is configured to:
receive a joint indication that indicates a common rate matching pattern and a UE-specific rate matching pattern.

7. The apparatus of claim 1, wherein to receive the common rate matching information, the at least one processor is configured to:
receive a control message that comprises a first indication of a common rate matching pattern and a second indication of a UE-specific rate matching pattern.

8. The apparatus of claim 1, wherein the common rate matching information indicates a pair of a common rate matching pattern and a UE-specific rate matching pattern from a set of rate matching pairs.

9. The apparatus of claim 1, wherein the common rate matching information includes a non-zero power channel state information reference signal (non-ZP CSI) configuration associated with a common message comprising the common codeword that is common to UEs to which the rate-splitting MU-MIMO communication is directed.

10. The apparatus of claim 9, wherein the at least one processor is further configured to:
receive the non-ZP CSI configuration from a network node.

11. The apparatus of claim 1, wherein the common rate matching information includes a zero power channel state information reference signal (ZP CSI) configuration that is common to UEs to which the rate-splitting MU-MIMO communication is directed.

12. The apparatus of claim 1, further comprising a transceiver coupled to the at least one processor, the transceiver being configured to at least receive the common rate matching information for the common codeword.

13. A method of wireless communication at a user equipment (UE), comprising:
receiving common rate matching information for a common codeword for a rate-splitting multiple user-multiple input multiple output (MU-MIMO) communication; and
decoding the common codeword of the rate-splitting MU-MIMO communication using the common rate matching information.

14. The method of claim 13, wherein the rate-splitting MU-MIMO communication includes the common codeword that is common to multiple UEs and a private codeword for the UE, the method further comprising:
receiving UE-specific rate matching information for the UE; and
decoding the private codeword of the rate-splitting MU-MIMO communication using the UE-specific rate matching information.

15. The method of claim 13, wherein the rate-splitting MU-MIMO communication includes the common codeword that is common to multiple UEs and a private codeword for the UE, the method further comprising:
decoding the private codeword of the rate-splitting MU-MIMO communication using the common rate matching information.

16. An apparatus for wireless communication at a network node, comprising:
a memory; and
at least one processor coupled to the memory and, based at least in part on information stored in the memory, the at least one processor is configured to:
provide common rate matching information for a common codeword for a rate-splitting multiple user-multiple input multiple output (MU-MIMO) communication; and
provide the rate-splitting MU-MIMO communication comprising the common codeword based on the common rate matching information.

17. The apparatus of claim 16, wherein the rate-splitting MU-MIMO communication includes the common codeword that is common to multiple user equipment (UEs) and a private codeword for a single UE, the at least one processor further configured to:
provide UE-specific rate matching information to the single UE for the private codeword comprised in the rate-splitting MU-MIMO communication.

18. The apparatus of claim 16, wherein the rate-splitting MU-MIMO communication includes the common codeword that is common to multiple user equipment (UEs) and a private codeword for a single UE, the common codeword and the private codeword being rate matched based on the common rate matching information.

19. The apparatus of claim 16, wherein to provide the common rate matching information, the at least one processor is configured to:
provide one or more rate matching configurations to a user equipment (UE); and
indicate to the UE a common rate matching configuration from the one or more rate matching configurations.

20. The apparatus of claim 16, wherein the common rate matching information is comprised in one or more of a radio resource control (RRC) message, a medium access control-control element (MAC-CE), or downlink control information (DCI).

21. The apparatus of claim 16, wherein to provide the common rate matching information, the at least one processor is configured to:
provide a joint indication that indicates a common rate matching pattern and a user equipment (UE) specific rate matching pattern.

22. The apparatus of claim 16, wherein to provide the common rate matching information, the at least one processor is configured to:
provide a control message that comprises a first indication of a common rate matching pattern and a second indication of a user equipment (UE) specific rate matching pattern.

23. The apparatus of claim 16, wherein the common rate matching information indicates a pair of a common rate matching pattern and a user equipment (UE) specific rate matching pattern from a set of rate matching pairs.

24. The apparatus of claim 16, wherein the common rate matching information includes a non-zero power channel state information reference signal (non-ZP CSI-RS) configuration associated with a common message comprising the common codeword that is common to user equipment (UEs) to which the rate-splitting MU-MIMO communication is directed.

25. The apparatus of claim 24, wherein the at least one processor is further configured to:
provide the non-ZP CSI-RS configuration to a UE.

26. The apparatus of claim 16, wherein the common rate matching information includes a zero power channel state information reference signal (ZP CSI-RS) configuration that is common to user equipment (UEs) to which the rate-splitting MU-MIMO communication is directed.

27. The apparatus of claim 16, further comprising a transceiver coupled to the at least one processor, the transceiver being configured to at least provide the common rate matching information.

28. An apparatus for wireless communication at a network node, comprising:
a memory; and
at least one processor coupled to the memory and, based at least in part on information stored in the memory, the at least one processor is configured to:
configure a first rate matching pattern for a first user equipment (UE);
configure a second rate matching pattern for a second UE to align with the first rate matching pattern for the first UE; and
provide a rate-splitting multiple user-multiple input multiple output (MU-MIMO) communication based on the first rate matching pattern and the second rate matching pattern, the rate-splitting MU-MIMO communication including a common codeword that is common to the first UE and the second UE.

29. The apparatus of claim 28, wherein the first rate matching pattern comprises at least one of a first non-zero power channel state information reference signal (non-ZP CSI-RS) configuration or a first zero power channel state information reference signal (ZP CSI-RS) configuration, and the second rate matching pattern comprises at least one of a second non-ZP CSI-RS configuration or a second ZP CSI-RS configuration.

30. The apparatus of claim 28, further comprising a transceiver coupled to the at least one processor, the transceiver being configured to at least provide the rate-splitting MU-MIMO communication.
